(19) United States
(12) Patent Application Publication
(10) Pub. No.: US 2026/0359864 A1
(43) Pub. Date: Nov. 12, 2026

(54) LOCATION-BASED NOTIFICATIONS FOR DYNAMIC DIGITAL ADVERTISING CONTENT

(71) Applicant: Design House, Inc., Chagrin Falls, OH (US)

(72) Inventors: Adam Zimmerman, Chagrin Falls, OH (US); David Gordon, Chagrin Falls, OH (US)

(21) Appl. No.: 19/669,912

(22) Filed: May 6, 2026

Related U.S. Application Data
(60) Provisional application No. 63/800,768, filed on May 6, 2025.

(51) Int. Cl. G06Q 30/0251; G06F 3/04842; G06F 16/955; G06Q 20/36

(52) U.S. Cl. CPC G06Q 30/0261; G06F 3/04842; G06F 16/9566; G06Q 20/36

(57) ABSTRACT

A dynamic digital advertising content system (DDACS) for displaying location-based notifications for digital advertising content for products sold by a retailer is disclosed. The DDACS may execute instructions associated with a digital wallet card associated with the retailer to continually determine the position of a consumer device, compare the position of the consumer device to a set of defined geographic locations, and present a corresponding notification to view digital advertising content, such as a weekly promotion, from the retailer. In response to selection of the notification, the consumer device may retrieve the corresponding dynamic digital advertising content from a network address associated with the notification, to obtain and display the dynamic digital advertising content to the consumer. As such, the system enables the delivery and presentation of the dynamic digital advertising content when the consumer is at a location where the dynamic digital advertising content would be most beneficial.

### CROSS-REFERENCE TO RELATED APPLICATIONS

This application claims the benefit of U.S. Provisional Patent Application No. 63/800,768, filed on May 6, 2025 which is incorporated herein by reference in their entirety.

### TECHNICAL FIELD

The present disclosure generally relates to consumer engagement materials, and more particularly, but not exclusively, to providing digital advertising content such as product promotions to consumers.

### BACKGROUND

Promotions for products may be provided to consumers via a variety of distribution systems, such as print, radio, television, and/or internet. However, providing the promotions at opportune times is technically difficult. That is, due to the technical limitations of the delivery system, a consumer typically views or otherwise learns of promotions at one point in time, such as when passively viewing a promotion on television, viewing a promotion in a printed publication, listening to a promotion on the radio, or seeing the promotion on a website at one point in time. At a subsequent time, the consumer may arrive at a retailer selling those promoted products. However, at that later time, the consumer may not have ready access to the information about that promotion. As such, the consumer may forget about the promotion and not take advantage of special pricing that the consumer could have otherwise availed himself or herself of.

Similarly, a consumer may miss an opportunity to utilize a promotion because the consumer is unaware that the retailer has a nearby location and/or the consumer may be preoccupied and the thought to utilize the promotion may not occur to the consumer until the consumer is no longer near the retailer’s location. Accordingly, existing systems for providing advertising content, such as promotions for products, have technical shortcomings that limit their effectiveness. Accordingly, there remains a need for further contributions in this area of technology.

### SUMMARY

Embodiments of the present disclosure relate to a system that displays notifications to users to view dynamic digital advertising content based on a continual determination of whether the user and a corresponding dynamic digital advertising content communications device is located at one of a set of defined geographic locations defined by a corresponding retailer. The system includes at least one processor, and a memory coupled with the processor. The memory includes instructions that when executed by the processor, cause the processor to obtain executable code encapsulated as a digital wallet card for a digital wallet of the dynamic digital advertising content communications device. The processor is further configured to enable notification and location tracking services associated for digital wallet cards in the digital wallet. Additionally, the processor is configured to continually determine, with the location tracking services, whether the dynamic digital advertising content communications device is at one of a set of geographic locations defined by a retailer in association with the digital wallet card. In addition, the processor is configured to display, in response to a determination that the dynamic digital advertising content communications device is at one of the set of geographic locations defined by the retailer in association with the digital wallet card, a notification that includes a prompt to select the notification to view the digital advertising content. Further, the processor is configured to request, in response to a determination that the displayed notification was selected, digital advertising content associated with the retailer at a network address defined in association with the notification. Additionally, the processor is configured to obtain, based on the request, the digital advertising content associated with the network address associated with the notification. The digital advertising content includes a promotion for a product sold by the retailer. The processor is further configured to display the obtained digital advertising content to enable a user of the dynamic digital advertising content communications device to readily utilize the promotion when the user is at one of the geographic locations defined by the retailer.

In an embodiment, a method may be implemented for displaying location-based notifications for digital advertising content for products sold by a retailer. The method may include obtaining, by a dynamic digital advertising content communications device, executable code encapsulated as a digital wallet card for a digital wallet of the dynamic digital advertising content communications device. The dynamic digital advertising content communications device is configured to enable notification and location tracking services associated for digital wallet cards in the digital wallet. The method further includes continually determining, by the dynamic digital advertising content communications device and with the location tracking services, whether the dynamic digital advertising content communications device is at one of a set of geographic locations defined by a retailer in association with the digital wallet card. Additionally, the method includes displaying, by the dynamic digital advertising content communications device and in response to a determination that the dynamic digital advertising content communications device is at one of the set of geographic locations defined by the retailer in association with the digital wallet card, a notification that includes a prompt to select the notification to view the digital advertising content. Further, the method includes requesting, by the dynamic digital advertising content communications device and in response to a determination that the displayed notification was selected, digital advertising content associated with the retailer at a network address defined in association with the notification. Additionally, the method includes obtaining, by the dynamic digital advertising content communications device and based on the request, the digital advertising content associated with network address associated with the notification. The digital advertising content includes a promotion for a product sold by the retailer. Further, the method includes displaying, by the dynamic digital advertising content communications device, the obtained digital advertising content to enable a user of the dynamic digital advertising content communications device to readily utilize the promotion when the user is at one of the geographic locations defined by the retailer.

Another embodiment of the present disclosure is a unique dynamic digital advertising content system. Other embodiments include apparatuses, systems, devices, hardware, methods, and combinations for providing location-based notifications for dynamic digital advertising content and/or dynamically viewing the same. Further embodiments, forms, features, aspects, benefits, and advantages of the present application shall become apparent from the description and figures provided herewith.

### BRIEF DESCRIPTION OF THE FIGURES

FIG. 1 illustrates aspects of an embodiment of a dynamic digital advertising content system (DDACS).

FIG. 2 illustrates an exemplary table containing product content and dynamic digital advertising content display information for the associated products that can be maintained at a back end system of the DDACS.

FIG. 3 illustrates a dynamic digital advertising content system that can accommodate interactions between a user and a retailer/client.

FIG. 4 illustrates an embodiment of a retail media network.

FIG. 5 illustrates an example of consumer devices engaged in a process of sharing a link or a card from dynamic digital advertising content.

FIG. 6 depicts another example of consumer devices engaged in a process for sharing a link to a category of cards from dynamic digital advertising content.

FIG. 7 depicts an example of consumer devices being used in the selection of a digital media advertisement for a category of products and being routed to a corresponding website having an associated category of cards for a corresponding category of products.

FIGS. 8-9 illustrate user interfaces that may be presented by a consumer device to download a digital wallet card associated with a retailer to display promotions from the retailer.

FIG. 10 illustrates a user interface that may be presented by a consumer device to display a digital wallet card associated with the retailer in a digital wallet of the consumer device.

FIG. 11 illustrates a user interface that may be presented by a consumer device with a location-based notification generated in association with a digital wallet card, prompting a user of the consumer device to view dynamic digital advertising content that includes a promotion from the retailer.

FIG. 12 illustrates a user interface with dynamic digital advertising content associated with the retailer that may be presented by a consumer device in response to detecting that a user of the consumer device selected a location-based notification associated with the digital wallet card.

FIG. 13 illustrates a map with a set of geographic locations defined by the retailer and utilized by the digital wallet card to trigger corresponding notifications to view dynamic digital advertising content associated with the retailer.

FIGS. 14-18 are flowcharts of a method that may be performed by the DDACS to provide location-based notifications to view dynamic digital advertising content.

### DETAILED DESCRIPTION OF THE ILLUSTRATIVE EMBODIMENTS

Embodiments of the disclosure generally relate to enabling a consumer using a corresponding consumer device to view dynamic digital advertising content, such as promotions for products sold by a corresponding retailer. In particular, at least some embodiments present a notification to the consumer to view the dynamic digital advertising content in response to a determination that the consumer, and in particular, a consumer device utilized by the consumer, is at one of a set of geographic locations defined by the retailer. The consumer device may execute instructions embedded in a digital wallet card associated with the retailer to continually determine the position of the consumer device, compare the position of the consumer device to the set of defined geographic locations, and present a corresponding notification to view digital advertising content, such as a weekly promotion, from the retailer. In response to selection of the notification, the consumer device may retrieve the corresponding dynamic digital advertising content from a network address (e.g., a uniform resource locator (URL)) associated with the notification, to obtain and display the dynamic digital advertising content to the consumer. By embedding the executable instructions into a digital wallet card for a digital wallet of the consumer device, the system enables the consumer device to continually perform the above location determination and notification operations when such operations are typically disabled, unless expressly enabled by the consumer, in other forms of executable instructions (application or “apps”) in the memory of a consumer device. Further, by presenting the notifications and dynamic digital advertising content in connection with a determination that the consumer device and the consumer are at one of the defined geographic locations, the system enables the delivery and presentation of the dynamic digital advertising content when that dynamic digital advertising content is most beneficial to the consumer and to the retailer. That is, for example, by notifying the consumer of the dynamic digital advertising content when the consumer is near the retailer’s store or otherwise has an opportunity to conveniently travel to the retailer’s store (e.g., when turning off of a highway exit), the system enables the consumer to more readily utilize the information in the dynamic digital advertising content.

The dynamic digital advertising content may be generated at least in part based on information stored in a back end system 70 system. The dynamic digital advertising content, in one form, is based on spatial positioning and content that is dynamically selected to visually organize and display a plurality of content items to the consumer. In an example embodiment, the dynamic digital advertising content is displayed on a system having at least one processor and a memory coupled with the processor, the memory including instructions that cause the processor to receive the dynamic digital advertising content based on a user a selection. Such a system capable of displaying dynamic digital advertising content according to parameters defined by a retailer enable more efficient and effective delivery and presentation of digital advertising content. A back end system 70 system complements the front end system 68 system and likewise includes at least one processor and a memory coupled with the processor, the memory including instructions that cause the processor to process the content, deliver content in response to corresponding requests, track the requests over time, and perform analytics to enable the retailer to understand patterns in the behaviors of consumers receiving notifications for the dynamic digital advertising content. In at least some embodiments, content capable of being processed on the back end system 70 can be uploaded by a client (e.g. a retailer) and/or retrieved and/or formed by the back end system 70 based upon a client request. The content can relate to the products to be displayed by the front end system 68 and associated content.

Various functions of and interactions between the front end system 68 and the back end system 70 are contemplated, including those related to various other entities/engines/networks. To set forth just a few non-limiting examples, third-party providers of services such as loyalty programs can interact with the back end system 70 to facilitate tracking and possible redemption of loyalty points with respect to purchases by the user. In some embodiments the various entities/engines/networks can exist separate from the front end system 68 and/or back end system 70, but in some forms can be integrated therewith. Continuing with a few other examples, the back end system 70 can include a portal through which a client (e.g. a retailer) uploads configuration information used by the back end system 70 to determine the layout of the dynamic digital advertising content. The back end system 70 can also include and/or be integrated with a personalization AI engine useful to ingest purchase history of a user to provide a customized digital advertising content. Various other entities/engines/networks are described in greater detail further below.

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

### System Overview

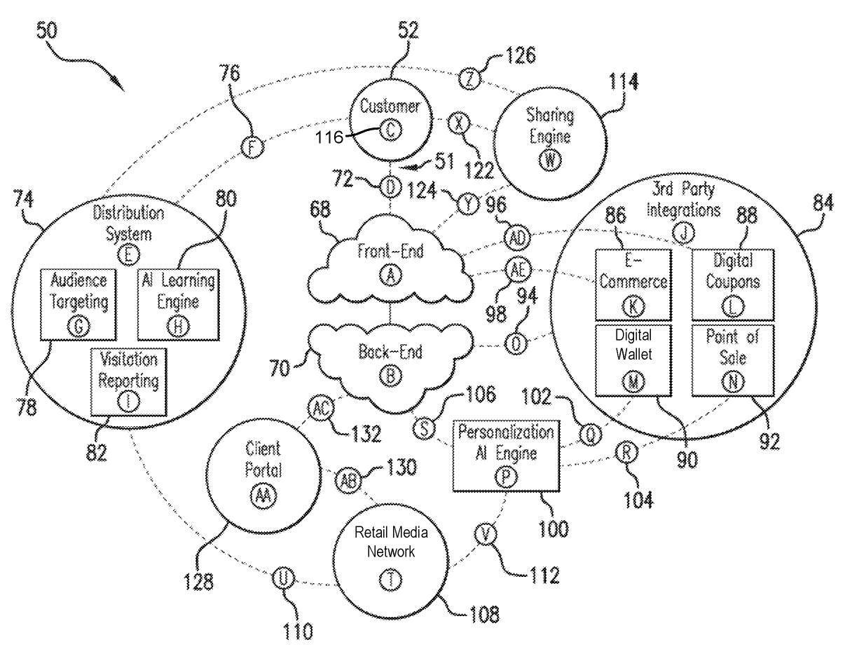

FIG. 1 illustrates aspects of an embodiment of a dynamic digital advertising content system (“DDACS”) 50, including a relationship between a user 52 and a retailer/client. The user 52 can be any person, user, organization, and/or entity, among others, that may be interested in perusing and/or purchasing products, goods, and/or services (collectively referred to herein as “product” or “products”) that are offered by, and/or through, the retailer/client. The retailer/client can be a person, organization, entity, business, seller, merchant, store, store chain, and/or franchise, among other entities, that is/are offering a product(s) for sale. As used herein, the term “retailer” or “client” can be used interchangeably as the terms can refer to a business or other organization engaged in the business of promoting and/or selling the product(s) to the user 52. As also discussed below, the DDACS 50 can also be operable to accommodate communications and engagement with/by third party participants other than the user 52 and retailer, including, for example, third party participants such as digital coupon providers and/or loyalty program providers, among others.

The DDACS 50 is adapted to accommodate generation of a digital advertising content that is customizable at least at an individual store, franchisee, and/or retailer specific level, as well as also be customizable among groups within an entity or organization and/or the entire entity or organization. As discussed below, the DDACS 50 can be dynamic in at least terms of the arrangement and/or presentation of information, including product content, in the digital advertising content in response to retailer and/or user 52 decisions and/or selections. Such engagement with the DDACS 50 by a user 52, retailer, and/or third party, including via the inputting of information and/or responses in/to the DDACS 50, can occur via use of a digital advertising content communications device, including via use of user interfaces provide by, or communicatively coupled to, digital advertising content communications devices. Moreover, a retailer, consumer 52, and/or third party can be able to engage with the DDACS 50 via use of a variety of different types of digital advertising content communications devices, including personal computing devices, such as a desktop computer, laptop, tablet, smart phone, and/or mobile or cellular device, among other computing devices.

According to certain embodiments, the DDACS 50 includes at least a front end system 68 and a back end system 70. The front end system 68 can include instructions for the display of product content and/or retailer information, among other information, on a user interface of a computing device. Moreover, as discussed below in more detail, the front end system 68 can be utilized to generate and/or transmit information in the form of dynamic digital advertising content for presentation on the computing device of the user 52, and/or for engagement with the user 52. For example, according to certain embodiments, the front end system 68, or the back end system 70, can generate dynamic digital advertising content in which information regarding products, also referred to as product content, among other information, can be arranged and/or presented for display on the personal computing device of the user 52. Additionally, the front end system 68 can receive inputs, such as, for example, selections, made by the user 52 via a user interface or input device of the personal computing device, including, for example, via a touch screen, keypad, and/or mouse, among others. According to certain embodiments, the front end system 68 is, or includes, a graphical user interface of a website that permits interaction by a user 52 with content published by the retailer via the DDACS 50.

In at least some instances, communications between the user 52, and moreover a computing device of the user 52, and the front end system 68 can occur via a channel 72. According to certain embodiments, the channel 72 can accommodate information from the front end system 68 being provided to the user 52 in the form of an on-line content, such as, for example, in the form of a website and/or software application (“app.”) that is accessible by the consumer 52, and which permits consumer interaction with content published by the retailer through the DDACS 50. As will be appreciated, the website utilized with/for the channel 72 can be rendered either on the front end system 68 or back end system 70, and in some forms can use isomorphic rendering with a render on the back end system 70 first and on the front end system 68 thereafter.

The channel 72 can be configured to accommodate communication between a computing device of a user 52 and the front end system 68 using any suitable type of wired and/or wireless connection, as well as via any suitable type of communication protocol, telecommunications hardware, and associated software. Thus, the connection 72 can be, but is not limited to, an internet enabled communication, a wireless connection (e.g., Wi-Fi, Bluetooth and, cellular, etc.), or a wireline connection (e.g., utilizes infrastructure delivering telecommunications to residences and or buildings). In short, any suitable digital medium through which a computing device of the user 52 can interact with the front end system 68 and view dynamic digital advertising content described herein is contemplated. The computing devices of users 52 may also interact with the DDACS 50 via through a retailer’s native software application, a downloaded Progressive Web App (PWA), or via a retailer’s website, including, but not limited to, a webpage or link to the DDACS 50 that is embedded directly on the retailer’s website.

The back end system 70 can generally be configured to accommodate input and/or content from a specific, or individual, retailer with respect to at least products or services that can be presented in a set of dynamic digital advertising content, which may, in some embodiments, be formatted as a digital circular. According to certain embodiments, the back end system 70 is a web-based software platform that can provide content management access for retailer websites, including, for example, content management can be performed by the retailer(s) and/or third parties. Further, the back end system 70 can be utilized for prioritizing the products that are to be presented in the dynamic digital advertising content, and/or the timing or duration at which specific products can be presented in the dynamic digital advertising content, among other features. According to certain embodiments, a client portal 128 can be provided that provides retailers access to the back end system 70 via a channel 132. Such a portal 128 can, for example, be a web-based software platform that is accessible to a retailer or other operator via a computing device.

The connection 132 between the client portal 128 and the back end system 70 can provide direct control over content management within the back end system 70. Thus, each retailer can have retailer specific credentials that can allow the retailer to at least access the back end system 70, and which may be utilized to access other features of the system 50, including the below discussed retail media network 108. Accordingly, access to the back end system 70 via the client portal 128 can also involve satisfaction of certain security measures, such as, for example, a password and/or two factor authentication. Additionally, permissions can be enabled to provide users of the back end system 70 control over different areas of the associated website for that particular retailer, including control over portions of the website that may be accessible to consumers 52 via the front end system 68.

Retailers can, via the client portal 128 and associated channel 132, provide or otherwise input a variety of information regarding a plurality of products to the back end system 70. Thus, for example, according to certain embodiments, the back end system 70 can comprise a database, data store, or other storage means. The manner in which product information can be provided, stored, edited, and/or removed by a retailer to/from the back end system 70 can vary. For example, according to certain embodiments, the back end system 70 can maintain a listing, such as, for example, a spreadsheet or table, among other manners of recording information regarding products. It will be appreciated that other types of data encapsulation and transfer to the back end system 70 are contemplated, such as, but not limited to serialization of the data and transfer via API calls. Additionally, or alternatively, individual retailers can, via use of the client portal 128, upload information to the back end system 70, such as, for example, upload a spreadsheet file containing text and artwork, among other product content, for one or more products. Further, data can be uploaded to the back end system 70 in a variety of other, or additional, manners, including, but not limited to, via a dynamic connection between the back end system 70 and one or more databases of the retailer(s), including, but not limited to, back office software, point of sales, and/or e-commerce systems, among other measures of data storage, as well as combinations thereof. Such a configuration can accommodate an uploading of relatively large amounts of information by the retailer to the back end system 70. Further, in addition to, or in lieu of, individual stores uploading information, the back end system 70 can also include nodes that can accommodate an uploading of product content that can be shared by different retailers, including, for example, shared by different branches or franchisees that may be related to a common parent organization or entity. In some embodiments the back end system 70 can be configured to create store groups which are useful to create efficiency in content management. The store groups can provide nodes where content can be uploaded for stores that share like content.

Accordingly, the back end system 70 can be utilized to archive and organize data related to a dynamic digital advertising content, including, for example, information related to product, value/pricing, promotional start and stop dates, among other data.

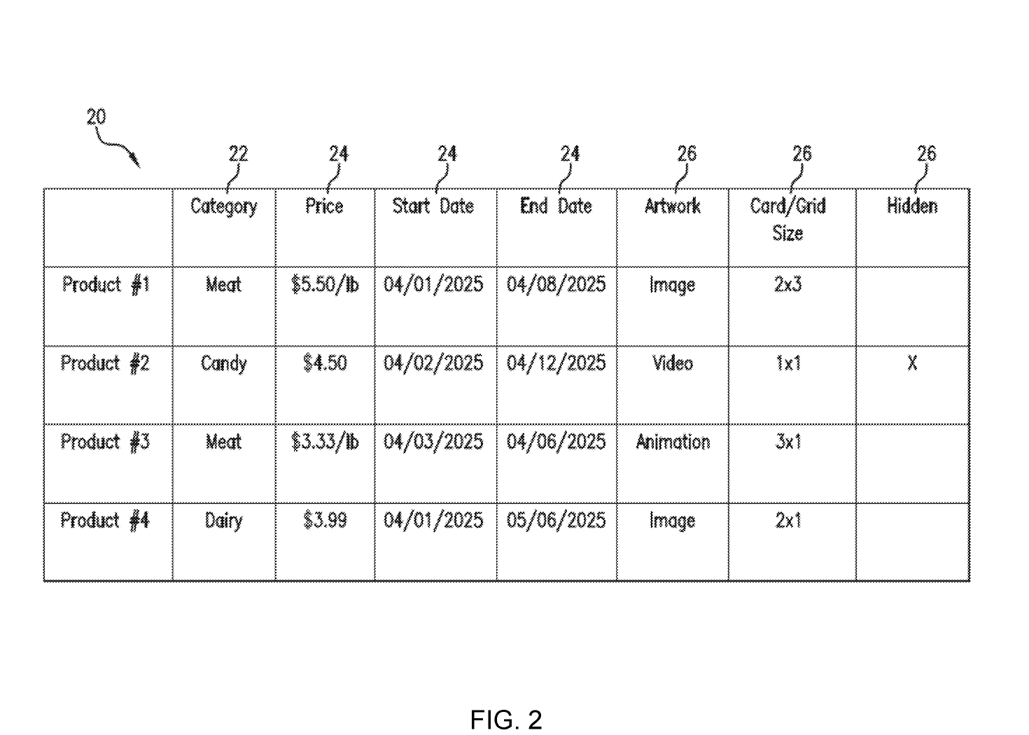

A non-limiting example of information that can be provided or uploaded to the back end system 70 is shown by the exemplary spreadsheet or table 20 shown in FIG. 2. While FIG. 2 illustrates an exemplary use of a spreadsheet 20, as discussed above, information can be provided to the back end system 70 in a variety of other manners, including, but not limited to, via a dynamic connection. As seen by the exemplary spreadsheet or table 20 depicted in FIG. 2, according to such embodiment, such a spreadsheet 20 can include either rows or columns that correspond to a product(s), and the other of the rows or columns can relate to characteristics, features, and/or sales for the products. For example, referencing the example shown in FIG. 2, according to certain embodiments, each row in the spreadsheet 20 can correspond to a different product (e.g. Product #1, Product #2, etc.), and the columns of the spreadsheet 20 can correspond to features or characteristics relating to the product and/or the sale of the product. Thus, in such an example, for each product, there may be one or product descriptor categories 22, one or more product sales categories 24, and/or one or more product display categories 26.

Product descriptor categories 22 can include, but are not limited to, an indication of a category to which the product can be grouped (e.g. meat, candy, dairy, cleaning supply, pastry, beverage, etc.), brand name, manufacturer, product size, and/or product quantities, among other characteristics or features of the product. With respect to at least the category to which the product can be grouped, group options available for selection when entering a particular product into the table can be predetermined

The one or more product sales categories 24 can include, for example, the sale price of the product, product discount or rebate information, and start and end dates for a sale of the product is to be available for display in a set of dynamic digital advertising content (e.g., in a digital circular) that is to be generated by the DDACS 50.

The one or more product display categories 26 can include an indication, or location, of the artwork that is to be used, if any, for the particular product in the set of dynamic digital advertising content, a size in a digital layout grid that the information regarding the product, including artwork, is to occupy in a layout (e.g., arrangement or format) of the set of digital advertising content, and whether the product is to be hidden with at least a first level of the set of digital advertising content. According to certain embodiments, the product display categories 26 can also include dates and/or time durations that the particular product is to be, or can be, displayed in the set of digital advertising content. The artwork for each product can correspond to a static image, animation, and/or video that can be stored by the back end system 70 and/or accessible or retrievable from a third party service. Examples of animations can include a looping animation. Animations shown for associated products in the set of digital advertising content can play automatically when the user 52 scrolls to a location in the set of digital advertising content where the product is shown in the display of the user computing device. It will be appreciated that animations can included not only moving images, but also relevant product details such as product name and/or price, among other information. In some forms the animation may run in the background while relevant product details remain in the foreground. To enable the animation, a user such as the retailer can upload the animation to the back end system 70, or the back end system 70 can be configured to extract a looped animation from a larger video. For example, according to certain embodiments, the artwork can correspond to a link to a video that is accessible via use of the YouTube^{TM} Data application programming interface (API).

Additionally, as discussed below, the information from one or more of the product descriptor categories 22, product sales categories 24, and/or product display categories 26, as well as information provided by those categories 22, 24, 26 can be utilized to prioritize which product content is to be displayed in the set of dynamic digital advertising content, and/or assist in the ordering and positioning of content for different products in a digital layout grid of the set of dynamic digital advertising content.

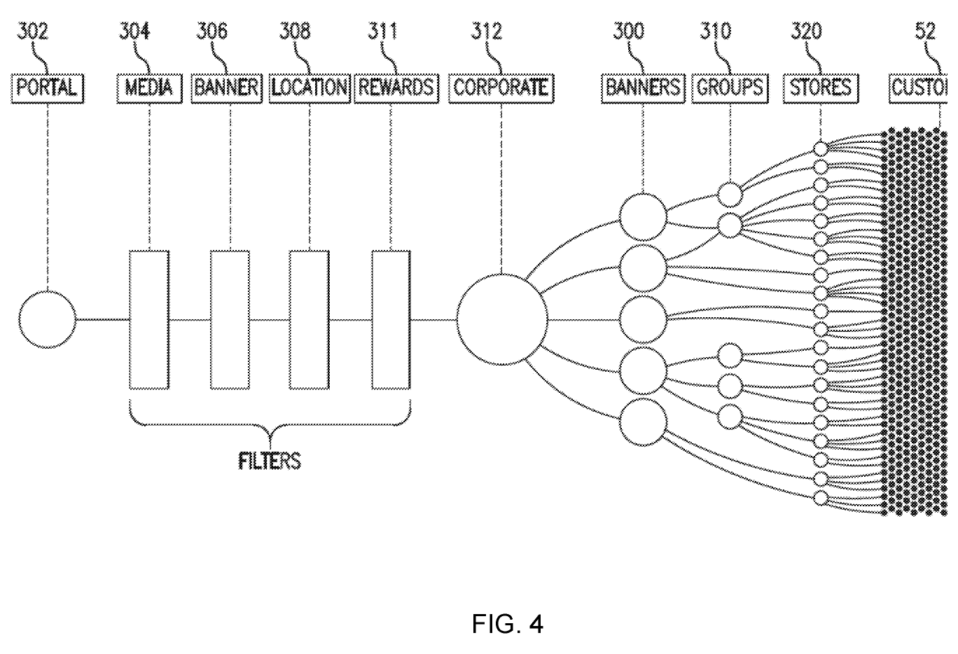

Referencing FIGS. 1 and 4, according to certain embodiments, the DDACS 50 can also include a retail media network 108. The retail media network 108 can be configured to assist retailers with connecting advertising partners with placement in the front end system 68, including with respect to placement in a set of dynamic digital advertising content, and/or targeted digital media campaigns. Moreover, the retail media network 108 can provide a web-based portal 302, as seen in FIG. 4 that can be directly accessed by retailers, agents that represent retailers, or advertising partners, so that those entities can initiate a media buy within the front end system 68 and/or in a distribution system 74. The web-based portal 302 of the retail media network 108 can also be used to communicate the details of the product content that such entities would like to publish, as well as be used to upload related artwork that may be utilized by the back end system 70. According to certain embodiments, the client portal can be connected to the retail media network 108 via a connection 130 that can enable retailers access to the retail media network 108 using their client portal credentials. Retailers may have third parties manage their advertising partners content and provide access by creating a new user in their Client Portal.

The retail media network 108 can also utilize media filters 304, which can include personality profiles of potential users within the media space, and in particular in the digital circular, to target an audience based on input by advertising partners. In some embodiments the retail media network 108 can also utilize banner filters 306 to focus media campaigns and/or content management to specific banner(s) 300 within a retailer’s purview. In addition, in some embodiments the retail media network 108 can utilize location filters 308 to focus media campaign and/or content management to a store or set of stores based on location. Additionally, in some forms the retail media network 108 can utilize reward filters 311 in which personality profiles based on rewards (loyalty) program purchase history is utilized to target an audience based on input by advertising partners.

Additionally, as also seen in FIG. 4, to aid in at least efficient management of digital content that can be received by the back end system 70, and/or published by the front end system 68, the retail media network 108 can be organized by groups 310. Such groups 310 can correspond to a collection of stores 320 that may part of a larger organization 312, and which serve and/or have at least digital interactions with consumers 52. Moreover, according to certain embodiments, the stores 320 in FIG. 4 can represent individual websites of individual retailers, including, for example, a unique websites for each retailer. According to such embodiments, the consumers 52 shown in FIG. 4 can represent all views or viewers of the “stores”, or the retailer websites.

The distribution system 74 can be configured to drive user 52, or virtual traffic, to the on-line content provided by the front end system 68, and more specifically, to the website(s) associated with individual retailer(s). The distribution system 74 can be adapted to utilize a variety of different tactics or approaches to drive consumers to such on-line content, including, for example, via targeted media buys. For example, the distribution system 74 can place ads in certain, or targeted, software applications or websites. In response to consumer 52 interaction with such ads, such as via user engagement with the user interface of a computing device, the consumer 52 can be taken to the retailer specific website, and, moreover, the website that for a specific, individual retailer or store.

The distribution system 74 can also be configured to interact with the consumer 52 via an information pipeline 76. For example, users 52 can interact with the distribution system 74 by engaging with certain types of online content, such as, for example, interacting with on-line advertising that may be in the form of websites, results from an on-line search, connected home devices, and/or software applications, among other online content. For example, while engaging with the distribution system 74 the user 52 may see and engage with an advertisement from/for a retailer, at which point the user 52 is driven through channel 72 to connect with the front end system 68.

According to certain embodiments, the distribution system 74 can also be configured to have an audience targeting system 78. The audience targeting system 78 can be adapted to selectively direct particular product information, including advertisements, to a user 52 based on, or using, information that has been obtained for that particular user 52, and which may be stored, for example, in a database of the distribution system 74 and/or the audience targeting system 78, among other databases of the DDACS 50, For example, the audience targeting system 78 can be adapted to utilized at least location information, such as, global positioning system (GPS) information from a computing device, including mobile devices, of the user, to identify the proximity of the user 52 to specific retailers. Such proximity information can be utilized to determine the retailer website to which the user 52 is to be directed. Further, target audiences can be built using the audience targeting system 78 at a given moment in time, and/or across a time span, using one or more different measures including, or, alternatively, other than, location information for the user 52, such as, for example, online search history(ies) and credit card usage data, among other information.

The distribution system 74 can also be configured to include a visitation reporting system 82. The visitation reporting system 82 can be configured to monitor, and/or record within a database of the visitation reporting system 82, information regarding interaction of users 52 with targeted digital media ads of a particular retailer, and moreover, a website for that particular, or individual, retailer. The visitation reporting system 82 can be further adapted to detect, such as, for example, via location tracking of a computing device of the user 52, a subsequent physical presence of the user 52 at that particular retailer, such as, for example, at a brick-and-mortar retail location of that particular retailer. Information regarding the monitoring of user interaction with a particular retailer’s website, and subsequent detection of the physical presence of the user 52 at the retailer, as indicated through the location of a computing device of the user 52 at the retailer, can be recorded in a visitation report in a database of the visitation reporting system 82, among other portions of the of the distribution system 74 and/or DDACS 50.

Data from such visitation reporting can be used for a variety of purposes and/or different types of reports. For example, such visitation reporting can permit the distribution system 74 to produce a location specific store visitation quantity, such as, for example, a total number of visits, total number of visits per user 52, and/or histograms of store visitations by hour of day, among other reporting. Information regarding visitations that is stored by the visitation reporting system 82 can also be used to determine a value associated with such visitations. For example, according to certain embodiments, the number of user visitations for consumers that interacted with the retailer’s website, as provided by the DDACS 50, can be compared with associated advertising costs incurred by the retailer to derive a cost per user visit report(s) for the retailer. Such reports can, for example, provide information regarding costs per visits during certain selected time periods. Additionally, such information can also provide a variety of other consumer analytics, such as, for example, the percentage of users 52 who interact the retailer’s website that then visited the retailer’s location that were new, repeat, and/or relatively long term absentee consumers in terms of either, or both, visiting the website and/or physically coming to the retailer’s physical store or location.

The distribution system 74 can also include an artificial intelligence (AI) engine 80. According to certain embodiments, the AI engine 80 includes one or more machine learning models. For example, the machine learning models may include neural network. The neural network may be embodied as a set of connected units (e.g., nodes) that are connected by edges. Each node receives signals (e.g., each a numeric value) from one or more connected nodes, processes the signals, and sends a corresponding output signal to other connected nodes. In processing a set of received signals, a node applies a nonlinear function, referred to as an activation function, to the sum of the numeric values (e.g., associated with the signals) received at that node. Further, a strength of each signal at each connection may be influenced by a weight. Each weight may be iteratively adjusted to reduce a resulting error in the output of the neural network.

The activation function may be, for example, a rectified linear unit (ReLU) activation function, a logistic sigmoid function, variations thereof, such as a Gaussian error linear unit (GELU) function, or other activation functions. In some embodiments, the machine learning models may include a deep learning model, which may be embodied as a neural network having three or more layers of nodes. Further, in a deep learning model, each layer passes on a more abstract representation of data to the next layer. Doing so enables enhanced identification of patterns and relationships within a data set. The machine learning models may include a model based on a transformer architecture, with multiple layers of neural networks. In such a model, each neural network has a set of parameters that may be tuned during training. One or more additional layers that form a structure known as an attention layer may focus the model on specific portions of a data set to increase the accuracy of the model in providing a human-like understanding of the underlying data set. In some embodiments, one or more of the machine learning models may initially be configured as a foundation model. That is, one or more of the machine learning models may initially be trained on a wide range of data to establish internal representations of relationships between data. Further, the foundation model(s) may be additionally trained to focus on the specific data set associated with the target application, to adapt a general intelligence of the foundation model to the specific application. In the illustrative embodiment, the model(s) of the AI engine 80 utilize recorded and/or stored information to improve the accuracy in identifying potential users 52 and/or target audiences that may be responsive to information outputted by the distribution system 74, as well as outputted from other portions of the DDACS 50.

Moreover, improving the accuracy in identifying users 52 to which particular types of different dynamic digital advertising content, including content in the form of digital circulars, from the distribution system 74 and/or DDACS 50 is to be directed can improve the efficiency of the distribution system 74. Further, over time, as data relating to the users 52 is accumulated by at least portions of the distribution system 74, including, by the audience targeting system 78 and/or the visitation reporting system 82, among other portions of the DDACS 50, the neural network of the AI engine 80 can further refine the effectiveness in the operation of the distribution system 74. Such improvements in refining the identification of target users 52 or audiences via use of a neural network of the AI learning engine 80 can result in an improvement in the efficiency of at least the distribution system 74, including, for example, with respect to reducing the cost per user visit (as discussed above with respect to visitation reporting), improve click through rates (CTR), as well as improving other key performance indicators (KPI). In some embodiments, the machine learning models may configured as an ensemble of machine learning models, in which an output of two or more models are combined by a supervisory model that adaptively adjusts weights applied to the outputs of the underlying models as a function of their prediction accuracy over time. Certain models may be rules-based models, such as decision tree models produced through gradient boosting, in which multiple weak learners are combined to form a strong learner. In such architectures, the weak learner models are iteratively trained by adjusting weights according to an error in predictions, to continually minimize a loss function.

According to certain embodiments, the accumulated, or inputted, data or information from at least the audience targeting system 78 and/or the visitation reporting system 82 can be used by the AI engine 80, and, moreover, the neural network that is provided by the AI engine 80, in connection with training and/or for machine based learning of the neural network. For example, historical information regarding past behaviors, responses, and/or actions/inactions of users 52 when engaging/not engaging content provided via the distribution system 74, among other portions of the DDACS 50, can be used by the neural network of the AI engine 80 in connection with a pattern analysis, as well as refinement of identified patterns. Such analysis can assist the neural network of the AI engine 80 in developing and/or refining a model that can provide a prediction of characteristics of users 52 that may, or may not, be responsive to particular types of content presented by the distribution system 74 and/or DDACS 50. Such information can thereby assist in identifying particular users 52, or users 52 having particular characteristics, to which to target, and/or those users 52 to not target, with particular content. According to certain embodiments, the neural network of the AI engine 80 can apply such data and information to one or more models, and, moreover, one or more neural network algorithms, such as, but not limited to, a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure.

The DDACS 50, and, more specifically, the front end system 68, can also include a sharing engine 114 that can be communicatively coupled to the distribution system 74 via a connection 126, as well as communicatively coupled to the computing device of a user 52 via a connection 122. According to certain embodiments, connections with the sharing engine 114 can be made using a tool built into a browser or software application (“app.”) that enables a special hyperlink to be sent. Such special hyperlink can be sent in a variety of manners, including in a text message, an email, or copied by the user and pasted elsewhere. Further, as represented by the connection 124 shown in FIG. 1, according to certain embodiments, the sharing engine 114 can be built directly into a user interface that is displayed on the computing device of the user, thereby providing users with relatively easy access to sharing functionality.

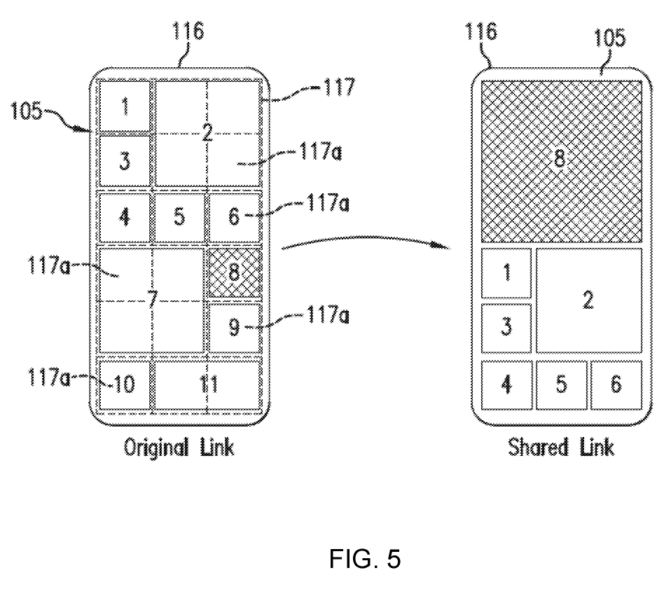

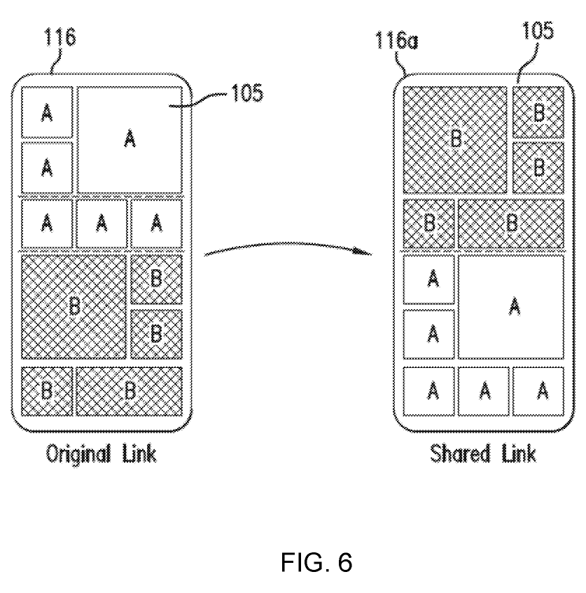

The sharing engine 114 can be configured to permit a user 52 to share content, such as, for example, content from or corresponding to a digital circular or other set of dynamic digital advertising content, and in the form of a hyperlink, with another user(s) 52. The hyperlink can correspond to information provided by, or in, a set of dynamic digital advertising content that was delivered to the computing device of the user 52. Further, such sharing of content can occur using a variety of different types of electronic communication, including, for example, via a text message and/or email, among other forms of electronic communication. As further discussed below in connection with FIGS. 5 and 6, if a user choses to share content with one or more other users 52, the shared hyperlink can contain special codes that can trigger a rearrangement of the visual depiction of the content on the computing device of the share recipient.

As also illustrated in FIG. 1, according to certain embodiments, the DDACS 50 can further include a third party integration system 84. The third party integration system 84 can be adapted to provide an access point for third parties to access the DDACS 50. As discussed below, such access by third parties can, for example, reduce the burden on retailers by allowing third parties to supply and/or update product, product content, and/or advertising information that is provided to the back end system 70. Such access can also allow the third parties to receive information directly or indirectly from users 52, thereby further reducing the amount of data or associated activities that retailers have to manage and/or track. By allowing the retailer to combine technical resources to streamline the management process, third party integration system 84 can provide an improved experience for the user 52.

The third party integration system 84 can be adapted to establish one or more third party integrations. For example, the exemplary embodiment depicted in FIG. 1 has multiple third party integrations, namely, an electronic commerce (“e-commerce”) integration 86, a digital coupon integration 88, a digital wallet integration 90, and a point of sales integration 92. According to certain embodiments, all third party integrations are contemplated to communicate with the back end system 70. Alternatively, as illustrated in FIG. 1, at least certain integrations 86, 88 can, in addition to, or in lieu of, being communicatively coupled to the back end system 70, can be directly or indirectly communicatively coupled to the front end system 68, such as, for example, by communication links 94, 96, 98, while other integrations 90, 92 can be directly or indirectly communicatively coupled to the back end system end system 70 by other communication links 102, 104. The communication links 94, 96, 98, 102, 104 can take a variety of forms, including, for example, be provided by a API, file integration, file transfer protocol (FTP), extract, transform and load (ETL), or a dynamic connection, as well as combinations thereof, among others.

The e-commerce integration 86 can correspond to an integration of a retailer and/or the DDACS 50 with a third party e-commerce provider. Such an integration can provide a third party e-commerce provider access to the DDACS 50 so that the e-commerce provider can upload content to the back end system 70, including updated product information, such as, but not limited to, information including sale offerings, promotional materials, product offerings, and/or price discounts, among other information, for products from the e-commerce provider that are sold by the retailer. Allowing a third party e-commerce provider to provide such information to the back end system 70 can reduce a content management burden on the retailer, particularly when the retailer would otherwise receive such updated information from a plurality of different a third party e-commerce providers for a plurality of different products.

Such access to DDACS 50 by third party e-commerce providers, and, moreover, access provided by the e-commerce integration 86, can also be configured to manage the sale and/or distribution of products that are purchased by a user 52. For example, the e-commerce integration 86, among other portions of the DDACS 50, accommodates items selected for the purchase by the user 52 while using the front end system 68 to be stored in a virtual shopping cart for that user 52. The e-commerce integration 86 can accommodate, with or without the knowledge of the user 52, items or products of the e-commerce provider in the shopping that are being sold by or through the retailer to an area that is retrievable by the associated third party e-commerce provider. Such movement of products can happen automatically each time a user 52 adds an item to their shopping cart, and/or can happen manually after a user 52 has built a shopping list and has proceeded to checkout or otherwise complete the purchase of the item(s) in the shopping list of the user 52.

The digital coupon integration 88 can be adapted to allow users 52 to view digital coupon offerings from third parties, including, but not limited to, product manufacturers or distributors, among others, directly within the front end system 68. Such coupons, and/or corresponding hyperlinks or other information, can be virtually clipped or otherwise stored to a digital wallet of the user 52 within the front end system 68. The digital coupon integration 88 can also be configured to accommodate third parties offering such coupons, or other sales incentives, to personalize such coupons for certain users 52, groups of users 52, and/or target audiences. Additionally, or alternatively, digital coupons can be configured to be store or retailer specific, such as, for example, being specific to a particular store or retailer location.

The digital wallet integration 90, in the illustrative embodiment, provides to a consumer computing device 116, a set of executable instructions encapsulated in or packaged as a card formatted for use in a digital wallet of the consumer computing device 116. The consumer computing device 116, by default, enables executable code associated with the digital wallet to perform location tracking operations (e.g., location tracking services) and notification operations (e.g., displaying notifications on a display of the consumer computing device), unlike executable code associated with other software applications, which typically require the user to expressly permit location tracking services and notification services for those applications. The executable code associated with the digital wallet card defines a set of operations to continually redetermine whether the consumer computing device 116 is at or within one of a set of geographic locations that have been defined by a corresponding retailer. If so, the executable code causes a notification to be displayed, prompting the user to click on the notification to view digital advertising content, such as a weekly promotion or advertisement (e.g., dynamic digital advertising content) for products sold by the retailer. The promotion may include, for example, special pricing for one or more products. Further features and operations of the executable code defined in connection with such a digital wallet card are described in more detail herein.

The point of sales integration 92 can provide visibility into store level inventory and pricing. For example, the point of sales integration 92 can provide third parties with access to information, on a retailer level, related to available inventory and pricing relating to products of, or relating to, the third party that are being sold through or by the retailer. The point of sales integration 92 can also provide third parties with access to sales information, sales quantity, prices paid for products, and details regarding the particular users 52 that purchased particular products, including personal identification information and/or demographics for those users 52.

In some embodiments, the third party integrations 84 include other integrations, such as a loyalty program integration. In at least some embodiments, a loyalty program integration may correspond to loyalty programs offered by third parties, such as, for example, programs offered by third party manufacturers or distributors, among others, whose products are sold by retailers of the DDACS 50. According to certain embodiments, embodiments, such a loyalty program integration can provide, to such third parties, historical information maintained by the DDACS 50, and/or maintained by the DDACS 50 for specific pre-identified retailers. Such historical information can include a purchase history of users 52 on an individual, retailer, and/or on a product basis, as well as combinations thereof. Further, the loyalty program integration can accommodate retailers having access to loyalty program information that is maintained by third parties, such as, for example, points accrued in a loyalty program(s) and/or user 52 eligibility for pricing or other benefits based on certain achievements the user 52 has obtained through participation in the loyalty program(s).

As seen in FIG. 1, at least portions of the third party integration system 84, such as, for example, the point of sales integration 92 or a loyalty program integration, can be communicatively coupled to a personalization artificial intelligence (AI) engine 100 of the DDACS 50. According to certain embodiments, the personalization AI engine 100 is part of the back end system 70. According to certain embodiments, the personalization AI engine 100 is a neural network that can utilize recorded and/or stored information to build personality profiles. Such personality profiles can relate to predictions relating to the types of product(s) a user 52, and/or users 52 having one or more particular types of identified characteristics, may, or may not, be likely purchase, and/or the types of advertising, discounts, and/or incentives that may, or may not, generate product sales from that/those identified user(s) 52. Further predictions generated by a neural network of the personalization AI engine 100 may result in a reorganization, or personalization in the arrangement, of products or categories of products that are presented to the user 52 via dynamic digital advertising content of the subject disclosure, that is presented on a display of the computing device of the user 52. Additionally, and/or alternatively, such personalization can involve certain products being removed from, and/or certain products being added to, a current generic version of the a set of dynamic digital advertising content, thereby further personalizing the set of dynamic digital advertising content that is presented to the user(s) 52. The personalization attained via use of the prediction(s) from the personalization AI engine 100 can also include a generation and display of an ancillary personal webpage of that particular user 52, such as, for example, a “Just For Me” webpage, that can be displayed on the computing device of the corresponding user(s) 52. Such an ancillary personal webpage can be provided and populated with products selected based on predictions made by the neural network of the personalization AI engine 100 as to products most likely be purchased by that user 52.

According to certain embodiments, the accumulated, or inputted, data or information used by the neural network of the personalization AI engine 100 in developing a model(s) and/or identifying patterns, can include purchase history data, demographic information regarding the users 52 and the associated purchase history of those users 52, reward and/or loyalty program data or purchase history, and point of sale information. As seen in FIG. 1, at least a portion of information used to develop and refine the model(s) utilized by the neural network of the personalization AI engine 100, including in connection with self-learning, can be provided by the retail media network 108, the loyalty program integration and/or the point of sales integration 92 of the third party integration system 84, among other portions of the back end system 70. However, the training and/or for machine based learning of the neural network of the personalization AI engine 100 can based on, or include, a variety of other types of information, including other information maintained by, or accessible to, the DDACS 50 regarding past behaviors, responses, and/or actions/inactions of users 52. Such analysis can assist the neural network of the AI engine 100 in developing and/or refining a model that can provide a prediction of characteristics of users 52 that may, or may not, be responsive to particular types of digital advertising content presented, and, moreover, a prediction of the digital advertising content that can successfully facilitate sale of product(s). According to certain embodiments, the neural network of the personalization AI engine 100 can apply such data and information to one or more models, and, moreover, one or more neural network algorithms, such as, but not limited to, a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure. Further, in at least some embodiments, the personalization AI engine 100 may use one or more machine learning models having an architecture other than a neural network, such as a decision tree architecture developed through gradient boosting. In yet other embodiments, the personalization AI engine 100 may utilize an ensemble of machine learning models, potentially having different architectures, and that are managed by a supervisory model that selectively adjusts weights of the outputs of the underlying models in the ensemble as a function of an error in the predictions of the underlying models over time (e.g., to continually reduce the error). The description of embodiments of machine learning models associated with the AI engine 80 applies equally to the personalization AI engine 100.

A variety of different types of communication protocols can be used in connection with the connections 102, 104, 106, 108 between the AI engine 100 with the third party integration system 84, the retail media network 108, and the back end system 70, including, for example, API, FTP ETL, and/or dynamic connections.

The ability to dynamically interact with promotional literature, such as dynamic digital advertising content, can ease the shopping experience for users 52 by making shopping more appealing and efficient. Embodiments of the DDACS 50 can provide users 52 with the ability to relatively rapidly call up specific retailer locations and have access to up-to-date information on promotional items being offered by that retailer. Unlike traditional printed promotional advertisements, retailers will also be able to update the content and customize, for purposes of display on the dynamic digital advertising content, the same with graphics, including animated graphics, without the need to wait for promotional cycle frequency. Further, unlike traditional printed promotional advertisements, the DDACS 50 of the subject disclosure provides the ability include embedded videos and recipes in a set of dynamic digital advertising content, which can deliver useful information to users 52. Additionally, by the DDACS 50 enabling users 52 to share content with other users 52, including individual merchandise promotions and/or embedded content, a more rapid dissemination of information between users 52 can occur.

While the DDACS 50 shown in FIG. 1 and discussed above has various features, not all embodiments of the DDACS 50 need include each element/capability/connection indicated by the various reference numerals of FIG. 1. Moreover, some embodiments may include fewer of the elements/capabilities/connections discussed above and indicated by the various reference numerals of FIG. 1.

### Dynamic Digital Advertising Content and Digital Layout Grid

As discussed above, the DDACS 50 can be utilized to generate and display a set of dynamic digital advertising content that can be personalized for particular user(s) 52, and can be generated on retailer specific level. In at least some embodiments, a set of dynamic digital advertising content may be embodied as a digital form a circular (a digital circular). A set of dynamic digital advertising content, unlike in conventional systems, is not limited to static, unchanging and unpersonalized content. In addition to being configured to dynamically select product content for a set of dynamic digital advertising content, such as in a digital circular, the DDACS 50 can also be adapted to dynamically organize, display, as well as rearrange and/or resize product content in such a set of dynamic digital advertising content based, at least in part, in response to user 52 engagement with the digital circular.

A generic representation of a digital circular 105 being shown on a display of an exemplary digital advertising content communications device 116 is shown in FIG. 5. The websites of the retailers can, through the DDACS 50, be displayed on the digital advertising content communications device 116 in a variety of manners, such as, for example, through a browser and/or a software application.

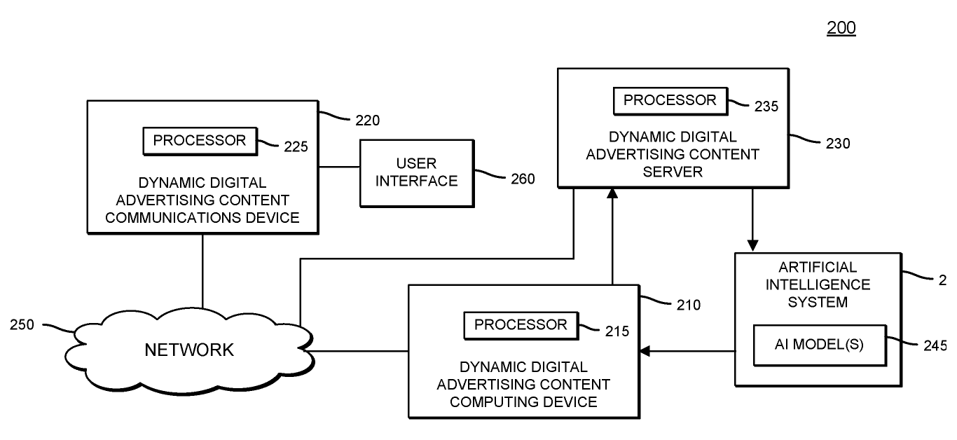

The illustrated digital advertising content communications device 116 is depicted in the form of a smartphone that includes a display or screen that can also provide a user interface, at least one processor 225 (FIG. 3) structured to execute instructions, and a memory coupled to processor 225. The memory can include instructions that, when executed by the processor 225, can cause the processor 225 to receive from the user 52 a selection of a digital circular location. The memory can also include instructions that, when executed by the processor 225, cause the processor 225 to present the digital circular 105, and thus an arrangement of the item cards 1-11, to the end user 522 via the display. As discussed, the display can be, for example, a screen associated with the digital advertising content communications device 116.

Dynamic digital advertising content communications device 220 may receive from an end user 52 a selection of a digital circular location. The digital circular location is associated with a retail location that the end user 52 requests to view the digital circular based on a current time frame in which the user 52 executes the selection of the digital circular location. The digital circular location is associated with a particular retailer, and moreover, a particular location or store associated with that retailer, for which the user 52 requests to view an associated the digital circular 105. The requested digital circular for a particular retailer or retailer location can be based, at least in part, on a current time frame and/or user location that the user 52 executes the selection of the digital circular location. Further, according to certain embodiments, the user 52 can request a digital circular location by either selection of a specific store location of a retailer, and/or a selection of a specific retailer. In some instances, a specific retailer may have more than one physical location, with each location having a digital circular associated with that particular physical location.

As discussed above, the front end system 68 includes the ability to display, through the digital circular and via the digital advertising content communications device 116, unique content specific to a particular store(s) of the retailer. Such an ability can permit a retail chain of the retailer to customize promotional materials for each store in its chain. The ability to display content such as a digital circular 105, for viewing consumption by a user 52 also includes the use of cookies to identify the particular digital advertising content communications device 116 used in the downloading of information, and/or to identify specific users 52. The cookies can be used to identify various details described herein as will be appreciated. However, according to certain embodiments, each retail location within a chain of stores can have, or have and/or the option to have, its own website. Such individual websites can permit store specific contact information to be published, as well as hyperlocal content to be published to an individual store. For example, a store in one geographic location may have ready access to locally harvested honey sold under the brand “Bob’s Honey,” but which supply of the honey is not readily available in faraway locations of the retail chain. An individual website for separate stores permits digital circular advertising of the hyperlocal content such as “Bob’s Honey”, while not burdening the circulars of the faraway stores in the retail chain with the same product that is not available at those particular stores.

Dynamic digital advertising content communications device 220 may request a digital circular that includes a plurality of item cards 1-11 that are created based on a plurality of item card parameters that are customized to the digital circular location and current time of the selected digital circular location from a dynamic digital advertising content computing device based on the digital circular location. The item card parameters can be indicative of a presentation of each item card 1-11 as displayed in the digital circular, and can be customized to a retailer priority of a digital circular retailer associated with the digital circular location to advertise to the user 52 and to a purchase priority of the user 52 to purchase retail items from the digital circular retailer. Moreover, product content in the digital circular 105 can be arranged in a grid like pattern in a digital layout grid 117. The digital layout grid 117 can comprise a plurality of item cards 1-11 spatially positioned into a plurality of corresponding item card partitions or cells 117a of the digital layout grid 117 for the digital circular 105 to dynamically display each item card 1-11 in an item card position and an item card size associated with each item card partition 117a to prioritize the display of each item card 1-11 in the digital circular 105 based on a plurality of item card parameters associated with each item card 1-11. Item cards 1-11 will be understood as a representation of a particular item to be displayed on the digital advertising content communications device 116, 220.

The dynamic digital advertising content communications device 116, 220 may instruct the user interface 260 to dynamically display each item card 1-11 in an item card position and an item card size associated with each item card partition 117a to prioritize the display of each item card 1-11 in the digital circular 105 based on the item card parameters. Each item card 1-11 is dynamically formatted with item card content to dynamically display each item card 1-11 with the item card content as spatially positioned in the digital layout grid 117 to prioritize the display of the item card content based on the item card parameters. Further, dynamic digital advertising content communications device 116, 220 may be configured to dynamically instruct the user interface 260 to display the digital layout grid 117 that is partitioned into the plurality of item card partitions 117a, wherein each item card partition 117a is displayed with a corresponding size and location in the digital layout grid 117 thereby enabling each item card 1-11 to be dynamically displayed in each corresponding item card partition 117a based on the item card parameters associated with each item card 1-11 in real-time.

The dynamic digital advertising content communications device 116, 220 may dynamically receive updates to the digital circular 105 as to each item card partition 117a that each item card 1-11 is spatially positioned based on the size and location of each item card partition 117a and the item card parameters associated with each item card 1-11 as the item card parameters are updated in real-time, thereby triggering a change in the item card partition 117a that each item card 1-11 is spatially positioned. Further, the dynamic digital advertising content communications device 116, 220 may dynamically instruct user interface 260 to display each updated item card partition 117a included in the digital circular 105 that each item card 1-11 is spatially positioned in real-time based on the size and location of each item card partition 117a as the item card parameters associated with each corresponding item card 1-11 are updated in real-time triggering a change in the item card partition 117a that each item card 1-11 is spatially positioned based on the size and location of each corresponding item card partition 117a.

Thus, in one form, the digital layout grid 117 comprises a plurality of item cards 1-11 spatially positioned into a plurality of corresponding item card partitions or cells 117a of the digital layout grid 117 of the digital circular 105. Thus, each item card 1-11 can be dynamically displayed in an item card position, which can correspond to a card petition(s) or cell(s) 117a, and with the item card size associated with how many card partitions or cells 117a are to be occupied by the item card. Further, the products can be prioritized in terms of which card petitions or cells 117a the associated item card 1-11 is to occupy, and whether certain item cards 1-11 for certain products are to have priority at certain card partitions or cells 117a over item cards 1-11 associated with other products. The item card parameters can thus be factors that influence a presentation of each item card 1-11 as displayed in the digital circular 105, and can be customized to prioritize purchase of products by the user 52 from a particular retailer, or retailer location, associated with the digital circular 105.

Item cards 1-11 can represent individual products, a grouping of products, a recipe, etc. Item card parameters can be set by a seller in the back end system 70, such as, for example, via parameters related to system settings defined in a spreadsheet or table 20 and uploaded by the retailer, where the item card parameters dictate the size of each item card 1-11 and can also dictate the priority given to each item card 1-11. Thus, the item cards 1-11 of the digital circular 105, as displayed via the digital advertising content communications device 116 by the front end system 68, can include an arrangement of products or merchandise that lists any variety of information about the products/merchandise, including but not limited to product name, picture, and price, among other information.

As previously mentioned, the item card parameters influence the presentation of each item card 1-11 as displayed in the digital circular on the digital advertising content communications device 116, 220, and are customized to the particular retailer associated with the digital circular location to advertise product(s) to, and entice purchasing by, the user 52. Each item card 1-11 is dynamically formatted either upon rendering and/or display with item card content to dynamically display by each item card 1-11. Further, the item card content can be spatially positioned in the digital layout grid 117 to prioritize the display of the item card content based on the item card parameters.

The digital circular 105 is shown as having an example of an arrangement of a plurality of item cards 1-11, all of which can act in concert with each other to display the digital circular 105. According to certain embodiments, the item cards 1-11 can correspond to product information provided by the above-discussed spreadsheet or table 20. Thus, for example, referencing the example provided by the table shown in FIG. 2, each item card 1-11 can correspond to a row shown in the table 20. Each row in the spreadsheet or table 20 can thus include relevant details necessary to populate the corresponding item card 1-11 when the digital circular 105 is displayed in a browser or software application on the digital advertising content communications device 116, 220 of the user 52. For example, as previously discussed, in the exemplary illustration, each row in the table 20 can include the name of the product, sale price (or related promotional value), file name associated with the graphic (or animation), alphanumeric identifier of the associated video, start date of the promotion, end date of the promotion, and/or the size of the cell(s) 117a that the item card 1-11 is to occupy in the digital layout grid 117, among other information. Further, FIG. 2 is merely one example of information that can be provided to the back end system 70, including, for example, via one or more spreadsheets 20 and/or a dynamic connection(s), Moreover, the actual information provided to the back end system 70 may, or may not, include at least some, if any, of the particular information identified in the example spreadsheet 20 shown in FIG. 2, among other information. Thus, FIG. 2 provides a non-limiting example of information that may be provided to the back end system 70.

Additionally, as illustrated in FIG. 2, the table 20 can also include information relating to whether the item card 1-11 for a product is to be a hidden card. Such a designation can indicate that the item card for the product is not to be displayed in the digital circular 105 unless some particular action is taken by the user 52, such as, for example, be hidden until the user 52 selects a particular, other item card 1-11 and/or selects another feature shown on the display. For example, according to certain embodiments, a hidden item card 1-11 may become unhidden, and thus displayed on the display of the digital advertising content communications device 116, 220 in response to the user selecting a recipe option that is displayed by, or navigated to, via interaction with the digital circular 105. In such an example, in response to the user selecting the recipe via engagement with the user interface, the recipe, as well as ingredients for the recipe, can be displayed on the display of the computing device. Such display of the recipe ingredients can thus cause a hidden item card to become visible. Alternatively, while viewing the recipe, a hidden item card 1-11 may become visible in response to the user 52 selecting the associated recipe ingredient.

The dynamic digital advertising content communications device 220 may receive the digital circular 105, which includes the plurality of item cards 1-11 from the dynamic digital advertising content computing device 210 that are spatially positioned into a corresponding item card partition 117a of a digital layout grid 117 for the digital circular 105. According to certain embodiments, in response to a user 52 requesting, via the digital advertising content communications device 116, a digital circular location, the front end system 68 can deliver, via channel 72, a digital circular 105 to the digital advertising content communications device 116. According to certain embodiments, the responsive communication from the front end system 68 that is received by the digital advertising content communications device 116 can include instructions that, when executed by the processor 225, cause the processor 225 to receive a digital layout grid 117 for the digital circular 105 that corresponds to a grid arrangement or format of product content for display on the digital advertising content communications device 116. FIG. 5 illustrates an exemplary digital layout grid 117 comprising a six row, three column (6x3) grid, and moreover a grid comprising eighteen 1x1 cells 117a. As seen in the exemplary depiction shown in FIG. 5, certain item cards 1-6, 10 occupy a single cell 117a (1x1 cell 117a), an item card 11 occupies a plurality of cells 117a in which the number of rows occupied by the item card 11 is not equal to the number of columns occupied that item card 11 (e.g. 1x2), and other item cards 2, 7 occupy a plurality of cells 117a in an equal number of rows and columns (e.g., 2x2). The actual number of cells 117a occupied by an item card 1-11, and moreover the size and arrangement of the item cards 1-11 in the digital layout grid 117 can vary, including varying during a session in which a user 52 is interacting with the digital circular 105, and thus interacting or engaging with the DDACS 50. Further, while FIG. 5 illustrates generally square shaped partitions or cells 117a in a generally rectangular digital layout grid 117, the partitions or cells 117a and/or the digital layout grid 117 can be configured to have a variety of other shapes. Thus, as will be appreciated from at least FIGS. 5-7, the digital layout grid 117 can be occupied with items cards 1-11, A, B of different sizes, and arranged with different sizes at various locations about the digital layout grid 117.

Additionally, the sizes of the partitions or cells 117a can be designated as a size having integer width and integer height, with the sum of the integer widths. For at least certain types of digital advertising content communications devices 116, 220, such as, for example, smart phones, in order to adapt to the anticipated size of the display of the computing device, the front end system 68 can be configured to limit the size of the digital layout grid 117, such as, for example, limiting the digital layout grid 117 to having a width corresponding to three partitions or cells 117a. In contrast to computing devices having smaller screen sizes, the front end system 68 can also be adapted to accommodate computing devices having relatively large displays, such as, for example, desktop computing devices. For such computing devices, the front end system 68 may cause the display of the website of a retailer(s) with a larger digital layout grid 117 width. In such embodiments, the front end system 68 may enable additional squares to be added to at least the width of the digital layout grid 117. Further, the front end system 68 may enable the number of squares to be selectively increased or decreased as a function of changes in the size of the browser window displayed on the user’s computing device (e.g., the dynamic digital advertising content communications device 116, 220). Thus, in some forms, the type of computing device being used by the user can be detected by the front end system 68, and appropriate adjustments can be made by the front end system 68 to the digital layout grid 117 and/or to the number or width of the corresponding partitions or cells 117a.

Additionally, the size of the item card 1-11, A, B, among other information regarding the format of the cards 1-11, A, B, can be set by the retailer when configuring the digital circular 105, such as, for example, via the client portal 128. For example, with respect to at least certain embodiments that involve the use of uploading spreadsheets 20 to the back end system 70, the retailer can specify the size of a particular item card 1-11, A, B in the spreadsheet or table 20 that is uploaded through the client portal 128 to the back end system 70. Thus, the manner in which the size, among other formatting, of the item cards 1-11, A, B is/are specified by the retailer can vary based on the manner or type of system used to provide the information to the back end system 70. Moreover, according to certain embodiments, such information can, for example, be provided by a retailer via use of a user interface, among other manners or inputting or providing such formatting information. Further, the content can be dynamically formatted, such as, for example, via the front end system 68, to include product content in the item card 1-11, A, B.

In some situations, the sizes of the item card 1-11, A, B set by the retailer, by another designer of the digital circular on behalf of the retailer, can inadvertently result in one or more empty spaces, such as empty partitions or cells 117a, when all item cards 1-11, A, B are arranged as designated. For example, if all item cards 1-11, A, B are default to a partition or cell 117a size of 1x1, but a few cards are designated in to another size, such as, for example, a 2x2 and 3x3 size, such an arrangement may result in a bottom row of the digital circular 105 that has a single 1x1 item card. To resolve this issue, the front end system 68 can be configured to dynamically format some or all of the item cards 1-11, A, B by resizing one or more of the item cards 1-11, A, B to fit within the digital layout grid 117 such that no blank or empty partitions or cells 117a remains. Whether an item card 1-11, A, B is capable of resizing can depend on the preference of the retailer, which the retailer can set in the back end system 70) or other limitations of the DDACS 50. It will thus be appreciated that the size of the item cards 1-11, A, B can be fixed or set by the retailer through the back end system 70, or, if unspecified, can be set to a default size (e.g. 1x1), with back end system 70 having the ability to resize if needed. It will be appreciated that the dynamic formatting of item cards 1-11, A, B can also include resizing of any information associated with the item cards 1-11, A, B.

Dynamic digital advertising content communications device 220 may instruct the user interface 260 to dynamically adjust the display to display updates to the digital layout grid 117 based on updates to the item card content. The spatial position of each item card 1-11 as displayed by the user interface 260 is dynamically adjusted as the item card parameters associated with each item card are updated. Further, dynamic digital advertising content communications device 116, 220 may dynamically receive updates to the digital circular as each item card 1-11 included in the digital circular 105 is updated based on the item card parameters associated with each corresponding item card 1-11 in real-time. Each item card 1-11 changes as the corresponding item card parameters associated with each item card change. The dynamic digital advertising content communications device 220 may dynamically instruct the display to display each updated item card included in the digital circular in real-time as the item card parameters associated with each corresponding updated item card change in real-time.

The dynamic digital advertising content communications device 116, 220 may dynamically receive updates to the digital circular 105 as a size associated with each item card 1-11 in the digital circular 105 is adjusted based on the item card parameters associated with each corresponding item card 1-11. That is, if the item card parameters are updated, the DDACs 50 may cause a real-time change in size associated with each item card 1-11 displayed by the corresponding dynamic digital advertising content communications devices 116, 220. A dynamic digital advertising content communications device 116, 220 may dynamically instruct the user interface 260 to display each updated size of each updated item card 1-11 included in the digital circular 105 in real-time as the item card parameters associated with each corresponding updated item card 1-11 are updated in real-time. Once the item cards 1-11, A, B are formatted, the item cards 1-11, A, B can be presented in the digital layout grid 117 to the end user 52 via the digital advertising content communications device 116. In some forms, the front end system 68 can be configured to dynamically receive and present updates to the digital layout grid 117 relating to product content that is to be shown in the item card(s) 1-A, B, and/or the spatial position of each item card 1-11, A, B as the item card parameters associated with each item card 1-11, A, B are updated. For example, if a retailer makes a change to the price of a product via the information uploaded to the back end system 70, such as, for example, a new, supplemented, and/or modified table 20, the front end system 68 can receive and communicate appropriate information to the digital advertising content communications device 116. Likewise, if a retailer adds and/or removes an item card 1-11, A, B, such as via edits or changes to the table 20, corresponding updates to the digital layout grid 117 can be received by the front end system 68 and communicated to the digital advertising content communications device 116 for display to the user 52. Still further, if a user 52 removes an item via the digital advertising content communications device 116 from the digital circular 105, updates to the digital layout grid 117 can be made (either through a subsequent request to the back end system 70 to update the circular 105 or processing by the front end system 68 to reflect the removal of the item card 1-11, A, B). Additionally, if a user 52 receives item cards 1-11, A, B from another user, the item cards 1-11, A, B displayed on the digital advertising content communications device 116 can be rearranged.

Dynamic digital advertising content communications device 116, 220 may dynamically receive updates to the digital circular 105 as to the item card partition 117a that each item card 1-11 is spatially positioned in. Dynamic digital advertising content communications device 116, 220 may dynamically instruct the display to display each updated item card partition 117a included in the digital circular 105 in real-time as the item card parameters associated with each corresponding updated item card 1-11 are updated in real-time, triggering a change in the item card partition 117a that each item card 1-11 is spatially positioned in. In one example, the digital layout grid 117 received by the front end system 68 at a first instance of time includes a first item card 1-11, A, B at a first size, and wherein the digital layout grid 117 at a second instance of time includes the first item card 1-11, A, B at a second size, wherein the first size is different than the second size. Such a change in size can be the result of either the retailer setting an updated size on the back end system 70, or the user 52 selecting the item card 1-11, A, B so that the item card 1-11, A, B can be expanded for further exposition of details related to the product that may not be present or as visible in the initial unexpanded view. In some forms, the expanded item card 1-11, A, B occupies a 3x3 cell 117a arrangement or space. Additionally, in some embodiments, the digital layout grid 117 at the first instance of time can include the first item card 1-11, A, B at the first size at a first item card partition or cell 117a space, and wherein the digital layout grid 117 at the second instance of time includes the first item card 1-11, A, B at the second size in a second item card partition or cell 117a space. A re-arrangement of item cards 1-11, A, B can, for example, be the result of the retailer updating details of the digital circular 105 on the back end system 70, where such updates are then shared, such as, for example, either pushed or pulled, to the front end system 68 when a refresh occurs. Updated details potentially include a re-sizing of the item card 1-11, A, B, and/or its inclusion in a different grouping of products, among other changes or modifications.

In response to receiving a selection of an item card 1-11, A, B by the end user 52, the front end system 68 is configured, via input received from the digital advertising content communications device 116, to determine an item type of the selected item card 1-11, A, B. As will be appreciated, the item card 1-11, A, B presented on the digital advertising content communications device 116 can be selectable by the user 52 through a finger press, button click, swipe of a slider, and/or other engagements with a user interface of the digital advertising content communications device 116, 220, and thereafter can be expanded on the digital advertising content communications device 116, 220 to include other details of the item cards 1-11, A, B and/or actions associated with the item cards 1-11, A, B as will be described elsewhere herein. In some forms, the item type relates to the type of item card 1-11, A, B associated with the product, such as, for example, whether the item card 1-11, A, B is a recipe card, or a link to a video, among other various forms of the item types.

As will be appreciated from the description herein, the digital advertising content communications device 116, 220 is further configured to dynamically receive updates to the digital circular 105 as each item card 1-11, A, B included in the digital circular 105 is updated based on the item card parameters associated with each corresponding item card 1-11, A, B being updated in real-time. With such updates, each updated item card 1-11, A, B can change as the corresponding item card parameters associated with that item card 1-11, A, B is changed. For example, when a retailer choses to update parameters to the back end system 70, corresponding changes can be reflected in real-time if content from the back end system 70 is pushed to the front end system 68. The digital advertising content communications device 116 is also further configured to dynamically instruct the display of the digital advertising content communications device 116, 220 to display each updated item card 1-11, A, B included in the digital circular 105 in real-time. Thus, the item cards 1-11, A, B in the displayed digital circular 105 can be updated as the item card parameters associated with each corresponding updated item card 1-11, A, B are changed in real-time.

In keeping with updates to item cards 1-11, A, B, such as through changes to content provided by a retailer to the back end system 70, the digital advertising content communications device 116 is further configured to dynamically receive updates to the digital circular 105 as a size associated with each item card 1-11, A, B in the digital circular 105 is adjusted. Again, such changes in size can be based on the item card parameters associated with each corresponding item card 1-11, A, B being updated in real-time. Moreover, changes in item card parameters can trigger a change in size associated with each item card 1-11, A, B as the corresponding item card parameters associated with each item card 1-11, A, B change. The digital advertising content communications device 116, 220 can also dynamically instruct the display of the digital advertising content communications device 116, 220 to display each updated size of each updated item card 1-11, A, B included in the digital circular 105 in real-time as the item card parameters associated with each corresponding updated item card item card 1-11, A, B are updated in real-time, thereby triggering a change in size associated with each item card 1-11, A, B.

Dynamic digital advertising content communications device 220 may dynamically receive updates to the digital circular 105 as to each item card partition 117a that each item card 1-11 is spatially positioned based on the retailer priority of the digital circular retailer to advertise to the user 52 and to the purchase priority of the user 52 to purchase retail items from the digital circular retailer, wherein the size and location of each item card partition 117a that each item card 1-11 is spatially positioned in is based on the retailer priority of the digital circular retailer to advertise and the purchase priority of the user 52 to purchase retail items. Further, dynamic digital advertising content communications device 220 may dynamically instruct the display to display each updated item card partition 117a included in the digital circular 105 that each item card 1-11 is spatially positioned in real-time as the retailer priority to advertise and the purchase priority of the user 52 to purchase are updated in real-time triggering a change in the item card partition 117a that each item card 1-11 is spatially positioned in, based on the size and location of each corresponding item card partition.

Dynamic digital advertising content communications device 116, 220 may dynamically receive updates to the digital circular 105 as to spatially positioning the item card 1-11 that has a decreased retailer priority and a decreased purchase priority in a second item card partition 117a that has a decreased size and a decreased centralized location as compared to item card partitions 117a with an increased size and increased centralized location. Item cards 1-11 with a decreased retailer priority and a decreased purchase priority are spatially positioned in corresponding item card partitions 117a with a decreased size and a decreased centralized location to decrease the likelihood of being identified by the user 52 when displayed to the user 52. Dynamic digital advertising content communications device 220 may dynamically instruct the display to display the second item card partition117a that has the decreased size and the decreased centralized location with the item card 1-11 as the retailer priority and the purchase priority associated with the item card 1-11 decreases in real-time, thereby triggering a change to being spatially positioned in the first item card partition 117a, to decrease the likelihood of being identified by the user 52 as displayed to the user 52 based on the decreased retailer priority and decreased purchase priority associated with the item card 1-11.

The DDACS 50 is also configured to update the position of item cards 1-11, A, B based on whether a product associated with that item card 1-11, A, B is to be prioritized, or has either an increase or decrease in prioritization by the retailer. Such prioritization of the product associated with that item card 1-11, A, B can be based, in part, on the purchase history of the user 52 to which the digital circular 105 is being generated. According to certain embodiments, such increase or decrease in prioritization can result in an adjustment in size and/or location of the card item 1-11, A, B within the digital layout grid 117, such that the associated item card 1-11, A, B is spatially positioned based on the product priority. Further, an increase in prioritization can result in an increase in size of the item card 1-11, A, B, as seen in digital circular 105 and/or placement of the card item 1-11, A, B in a partition(s) or cell(s) 117a located a higher and/or more central location in the digital layout grid 117. Conversely, a decrease in prioritization can result in a decrease in size of the item card 1-11, A, B, as seen in digital circular 105 and/or placement of the card item 1-11, A, B in a partition(s) or cell(s) 177a located at a lower and/or outer location in the digital layout grid 117. Such updates and changes in size and/or positioning of card items 1-11, A, B can be updated on the display of the digital advertising content communications device 116 generally in real time.

As previously discussed, the table 20 containing product content, at least some of which is displayed via an associated item card 1-11, A, B can include static images, animations, and/or video. Video can be embedded directly into the front end system 68 to allow consumers 52 to watch videos on the digital advertising content communications device 116 of any length, and with audio included. At least some, if not all, of such videos may be hosted by a third party such as, for example, YouTube or Vimeo, or, may be hosted directly on the back end system 70.

Information related to the video can be stored in the back end system 70 as thumbnails and an alphanumeric identifier known to the video provider. In one embodiment the back end system 70 can query a public facing API associated with a video provider to pull the video and embed it in to the displayed card. In this manner the content presented on the item card 1-11, A, B in the digital circular 105 can display a thumbnail when viewed by the user 52 on the digital advertising content communications device 116, and can thereafter be replaced with the embedded video on the digital advertising content communications device 116 if the user 52 selects, via the user interface 260, the item card 1-11, A, B. Specifically, a thumbnail video can be used in place of the video until selection by the user 52 and, when selected, the item card 1-11, A, B can be dynamically re-formatted by the front end system 68 in which the item card 1-11, A, B thumbnail content is replaced with an embedded video.

If video is uploaded to the back end system 70, the back end system 70 can be configured to compress the video into different formats useful for different devices and operating systems. When a user 52 scrolls to the card designated to display the animation, the front end system 68 can detect the type of device and operating system (e.g. by consuming metadata from the browser) of the digital advertising content communications device 116, and select the appropriate format. If the digital advertising content communications device 116, including the associated operating system, is not supported, a still image can be taken from the uploaded animation and displayed in the consumer’s browser on the digital advertising content communications device 116. The still image can either be designated by the user on the digital advertising content communications device 116, by an operator of the back end system 70 via the digital advertising content communications device 116, or can be designated as an image available at a certain time within the animation (e.g. an image available 1 second, among other times, after start of the animation, or available 30% into the animation, among other possibilities).

In response to receiving a selection of a particular item card 1-11, A, B by the end user 52, such as, for example, through use of a user interface of the digital advertising content communications device 116, 220, an item type associated with the selected item card 1-11, A, B can be determined. The item type can include whether the selected item card 1-11, A, B is associated with an individual product, a family of products, and/or a recipe, video, or animation. In short, several different types of item cards 1-11 are contemplated for display with the digital advertising content communications device 116, as will be appreciated from the discussion herein.

The front end system 68 can also be configured to receive from the user 52 a selection of a category selector useful to group products/merchandise by category. Specifically, the item cards 1-11, A, B can be arranged into categories determined by information designated by the retailer and stored in the back end system 70. The front end system 68 can be configured to display the item cards 1-11, A, B into respective categories to which the item cards 1-11, A, B belong, by activating a category selector, or can be configured to ignore categories if such selector is not activated. Such selection of whether or not to segregate item cards 1-11, A, B into categories can be made by the retailer via the back end system 70, which can be enabled by the retailer computing device 210 (FIG. 2), the user 52 on the digital advertising content communications device 116, 220, or both. To set forth an example, milk and yogurt and cheese can be grouped into a “dairy” category, hamburger buns and hot dog buns can be grouped into a “bread” category, and so on. The category selector is associated with a category selector arrangement of the digital circular 105 wherein the plurality of item cards 1-11, A, B are spatially grouped in the digital circular 105 such that a first group of items cards from the plurality of item cards 1-11, A, B associated with a first category are spatially grouped together and a second group of items cards from the plurality of item cards 1-11, A, B associated with a second category are spatially grouped together apart from the first group. To continue with the example from above, products in the “bread” category can be grouped together and set apart from products in the “dairy” category. Each of the items cards 1-11A, B can have an item card parameter specifically designating which category to which the item card 1-11, A, B belongs. If an item card 1-11, A, B does not have an item card 1-11, A, B parameter designating a particular group then the front end system 68 need not include it in any category if sorted by category by the user 52.

A user 52 can add, via the digital advertising content communications device 116a, an item card 1-11, A, B shown on the digital circular 105 to a shopping list that can be viewed on the digital advertising content communications device 116 by selecting the item card 1-11, A, B. The shopping list can include a list of items chosen by the user via the digital advertising content communications device 116. The shopping list can be populated either through the inclusion of a recipe on the shopping list, or through selection by a user 52 of individual item cards 1-11, A, B in the digital circular 105. Items can be added or removed at will on the selection of the user 52 via the digital advertising content communications device 116. According to certain embodiments, the details of the selected item card 1-11, A, B can be expanded by the front end system 68 on the display of the digital advertising content communications device 116, before being added to a shopping list. Further, the shopping list can be maintained on the communication device 116, the front end system 68, and/or the back end system 70.

Dynamic digital advertising content communications device 116, 220 may receive a selection from a user 52 that requests an item card 1-11 to be expanded to display item card details associated with the selected item card 1-11 not previously viewable in the digital circular 105 initially displayed to the user 52. Dynamic digital advertising content communications device 220 may dynamically instruct user interface 260 to display an expanded item card detail view that displays the item card details associated with the selected item card 1-11 not previously viewable in the digital circular 105 initially displayed to the user 52. The expanded item card detail view replaces the digital circular 105 initially displayed to the user 52. The addition of product to the shopping list can be accomplished by the user 52 selecting, via the digital advertising content communications device 116, an expanded item card 1-11, A, B (e.g. selecting a ‘shopping list’ icon, etc.). In response to receiving the identification of the targeted item card 1-11, A, B selected by the end user 52, the front end system 68 can add the targeted item card 1-11, A, B to the shopping list for that digital advertising content communications device 116. The front end system 68 can also be configured to store a shopping list having a collection of item cards 1-11, A, B related to promotional items and/or hidden item cards 1-11, A, B associated with recipes that can become viewable on the digital advertising content communications device 116 in response to a user 52 making a selection on the digital advertising content communications device 116 that opens or expands an associated recipe. The shopping list can be viewable on the digital advertising content communications device 116 in a number of different manners. For example, the shopping list can be accessed through the push of a display button on the digital advertising content communications device 116 and/or loaded to the screen on the digital advertising content communications device 116.

The front end system 68 can also enable the functionality to share a shopping list from one consumer to another consumer, also referred to as a shared recipient. Moreover, the front end system 68 can also accommodate the sharing of selected items, including items selected for the shopping list, between different user digital advertising content communications devices 116, 116a. Such sharing, can include, for example, sharing items from the shopping list of one or more user digital advertising content communications devices 116, 116a. Thus, items can be selected and shared by one digital advertising content communications device 116 to another other digital advertising content communications device 116a, including a digital advertising content communications device 116a of another, or different, user 52. In some instances, such selection can be pushed to the digital advertising content communications device 116 of the user 52 by a selection, by that user 52 or another user, of an item card 1-11, A, B via use of a different digital advertising content communications device 116a. For example, selections made on one digital advertising content communications device 116 from a recipe can be added to, or shared with, a shopping list that is one another digital advertising content communications device 116a, and vice versa.

Examples of dynamic digital advertising content communications device 116, 116a, 220 may include a mobile telephone, a smartphone, a workstation, a portable computing device, other computing devices such as a laptop, or a desktop computer, cluster of computers, set-top box, a product inventory checking system and/or any other suitable electronic device that will be apparent to those skilled in the relevant art(s) without departing from the spirit and scope of the invention.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

The front end system 68 can also provide the ability to permit the user 52 to “Proceed to Checkout” and have items from the shopping list be purchased online and available for pickup at the store or delivery to the home.

In some forms, a digital advertising content communications device 116a can receive, via the front end system 68, one or more item cards 1-11, A, B that were sent from another digital advertising content communications device 116, including a digital advertising content communications device 116 of another user. Further, in such situations, the DDACS 50 can be configured, via the front end system 68, to dynamically format the digital circular 105 shown on the digital advertising content communications device 116a that is receiving the shared item cards 1-11, A, B so as to prioritize in the item cards 1-11, A, B that are being sent from the other digital advertising content communications device 116. In this form, one or more functional blocks of the DDACS 50 may receive a plurality of item cards 1-11, A, B transmitted from one digital advertising content communications device 116, insert the transmitted plurality of item cards 1-11, A, B into a plurality of corresponding partitions or cell 117a into a digital layout grid 117 of a digital circular 105, and communicate that digital circular 105 to the other digital advertising content communications device 116a. Further, the DDACS 50 can be configured to insert transmitted item cards 1-11, A, B at one or more preselected locations in the digital layout grid 117, such as, for example, along the top row of the digital layout grid 117 and/or increase a size of the transmitted item cards 1-11, A, B in connection with prioritizing those item cards 1-11, A, B.

Such an example is provided by FIG. 5, wherein a single item card 8 is shared from a first digital advertising content communications device 116 to a second digital advertising content communications device 116a, and, moreover, to a shared recipient. In this example, a user 52 has chosen to share product content, as represented by item card 8, with another user 52, or shared recipient, by selecting such action using the digital advertising content communications device 116. In some embodiments, a link corresponding to digital circular 105 that was provided to the digital advertising content communications device 116 of the first user can with, or loaded onto the digital advertising content communications device 116a, of the shared recipient, but with particular changes relating to the reorder and/or size of the displayed item cards 1-11. Moreover, as seen, while, with respect to the digital circular 105 shown on the first digital advertising content communications device 116, item card 8 is positioned in a single cell 117a located on at an outer portion of a mid-section of the digital layout grid 117. The DDACS 50 however reformats the digital circular 105 for the second digital advertising content communications device 116a so that item card 8, as seen on the digital circular 105 shown in the second digital advertising content communications device 116a, is increased in size and is positioned at the top section and/or rows of the digital layout grid 117 of the digital circular 105. Further, in the illustrated embodiment, the reordering of the item cards 1-11, and associated resizing of item card 8, can result in item card 8 being automatically expanded to a size associated with an expanded or detail view. It is also worth noting that item cards 1-7, 9-11 below item card 8 can be resized by the front end system 68 if necessary, using any of the techniques disclosed herein. For example, moving item card 8 to the top of the screen on the digital advertising content communications device 116 could leave an opening or blank space at the original location of item card 8, as seen in the digital circular 105 shown in the first digital advertising content communications device 116. To avoid a blank space, any of the other item cards 1-7, 9-11 can be resized by the front end system 68 from their default or designated position (as determined by the configuration stored in the back end system 70) to be a different size.

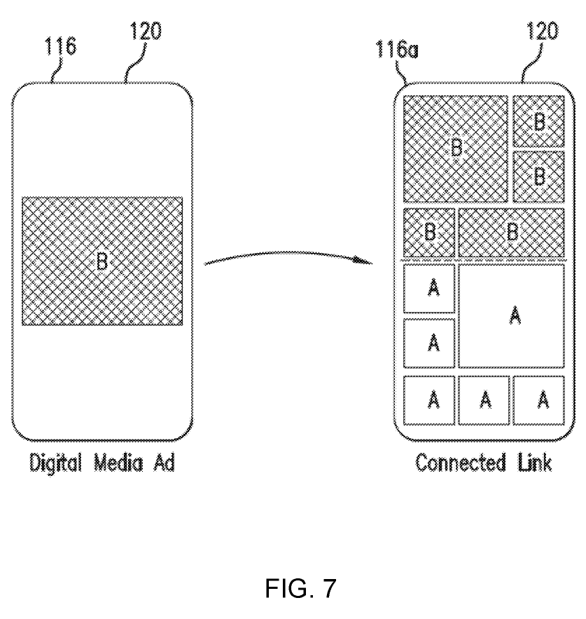

FIGS. 6 and 7 also further illustrate various embodiments of receiving to the front end system 68 one or more item cards 1-11, A, B from another user. FIG. 6 is similar to FIG. 5, but on the basis of a category of item cards B being shared, instead of just a single card. Moreover, the user 52 of the first digital advertising content communications device 116 can select and share all item cards in “Category B.” The category can be based on a variety of different criteria, including for example, a based on an indication of a category to which the product can be grouped, as discussed above. The link provided from the digital advertising content communications device 116 to the front end system 68 can indicate that digital advertising content communications device 116a of the share recipient is loaded with the same webpage, and moreover, the same digital circular 105 that was uploaded by the first digital advertising content communications device 116, but with changes to the digital circular 105 so as to rank the item cards A, B associated with “Category B” so that item cards B appear at the top of the webpage, and item cards A associated with a category(ies) other than “Category B” are at a lower position in the digital layout grid 117 and/or the digital circular 105.

Turning now to FIG. 7, using the methodology associated with the “Category Share” function depicted in FIG. 6, a digital media ad can use a “category share” link when driving traffic to a webpage. This permits the digital media ad for “Category B” to drive traffic to a webpage with “Category B” at the top of the page, or, alternatively permits the digital media ad to drive traffic to a webpage with “Category A”, as shown at the lower portion of the gird shown in FIG. 7.

Using the methodology previously discussed above with respect to FIG. 7, digital ads can be used by political candidates to drive traffic to a centralized webpage, resulting in the rearrangement of categories to allow each candidate’s content (category) to appear at the top of the webpage for all traffic driven by their Digital Ad Campaign. An expansive political unit such as a country can be divided into local regions, with groups of local regions comprising state regions, and all state regions comprising a national region. Each local region can be assigned its own webpage. Candidates on the national level can appear in all webpages, while candidates on the state level will appear in all regions comprising that state. Candidates on the local level will appear within a single local region, or a group of local regions. Such a political marketing system adapted to the framework of FIG. 7 can be used by a single political party, with different and separate systems created for each different participating political party.

In one form the front end system 68 can be used to initiate a conversion of a parent item card B to a child item card A, B, wherein the parent item card B includes item content directed to a grouping of goods, and wherein the child card includes item content directed to particular goods within the grouping of goods of the parent card. Some item cards A, B may be related to other cards through a parent-child relationship. For example, a parent item cards A, B may include information related to a family of products (e.g. Coca-Cola TM ), and through a selection of the parent item cards A, B the user 52 can be presented with a child item cards A, B related to distinct beverages within the family (e.g. Fanta TM , Barq’s TM , etc.). The parent item cards A, B can take on any suitable size (subject to the width restrictions described herein in some embodiments). For example, the parent item cards A, B can be a 1x1 size card with ‘Coca-Cola TM ’ text appearing in the item card A, B. When selected on the digital advertising content communications device 116, the 1x1 parent item card A, B can be converted by the front end system 68 to a 3x3 child item card A, B. Other sizes for both parent and child item cards A, B are contemplated.

In some forms one or more item cards 1-11, A, B in the digital circular 105 is a recipe item card. The recipe card can be accessed by action from the user 52 via the digital advertising content communications device 116, such as but not limited to selecting the item card 1-11, A, B using a user interface of the digital advertising content communications device 116. In response to receiving a recipe card selection by the end user 52 of the recipe item card 1-11, A, B, the front end system 70 can present a recipe item over the digital layout grid 117 via the display. In some forms, ingredients listed on the recipe item card 1-11, A, B can correspond to other item cards 1-11, A, B in the digital circular 105. However, in some forms, ingredients listed on the recipe card can also include a hidden item card that is apart from the item cards 1-11, A, B in the digital circular 105. In particular, the hidden item card, including content of the hidden item card 1-11, may not at least initially be presented to the end user 58 via the display of the digital advertising content communications device 116 until the recipe card selection has been made by the end user 52. Thus, information associated with the recipes can be stored in the back end system 70 and displayed when needed by the front end system 68. Such information can include item cards for products that are not on promotional sale in the digital circular 105, but that nevertheless are available for viewing if the user 52 selects the recipe. Thus, such hidden cards can be considered ‘hidden’ until the recipe is selected by the consumer.

The user 52 may view information displayed on the digital advertising content communications device 116 related to a recipes that has been prepared by a retailer as the retailer seeks to promote ingredients useful in the recipe. If a user 52 selects a recipe card the ingredients can slide out of a side of the display screen. In some forms video content can be embedded into the display of the digital advertising content communications device 116 that is viewable by the user 52. The videos can include a guide on how to make the recipe. If desired, the user 52 can elect to add the recipe to a shopping list viewable on the device, and/or added to a cookbook also viewable on the device 116.

Pages related to the recipes can include static images, videos, instructions and ingredients, and retail products that may be added to the shopping list of the user 52. For example, if a user 52 selects a recipe card via the digital advertising content communications device 116, the user 52 can also be presented on the digital advertising content communications device 116 with a choice front end system 68 to add the ingredients to shopping list. The ingredients can be products promoted in the digital circular 105, including, for example, as being on sale, and/or can include products unrelated to products that are presently being promoted.

In some forms, the digital circular 105 can include content displayed in the item cards 1-11, A, B in one language but, if selected via the digital advertising content communications device 116 by the user, can be changed to being displayed on the digital advertising content communications device 116 in another language. Thus, the content of the item cards 1-11, A, B can be dynamically re-formatted by the front end system 68 and/or the back end system 70 in which the display of the content of the item card 1-11, A, B in a first language is replaced with a second language. The item card 1-11, A, B content in the second language can also include a graphic having text displayed in the second language. Retailers may wish to configure the back end system 70 to provide support for as many languages as they prefer. Such configuration of the back end system 70 can include uploading information related to a first language as option “A” and information related to a second language as option “B.” Additional options are contemplated. Such options include a title and description in a first language and similar information in a second language. As the table 20 may connect different images/animations/video with languages, changes in languages or language preferences can also change the images/animations/video, if any, provided in one or more item cards 1-11, A, B. A retailer may therefore assign multiple images to a specific item card or graphical card, e.g., if language “A” is selected image “A” is used, otherwise if language “B” is selected image “B” is used, and so on.

Once enabled, the website can detect the language of preference set in the user’s web browser on the digital advertising content communications device 116 and activate that language automatically. Users can also have the ability to toggle from one language to through interaction with the front end system 68 interface. As will be appreciated from the discussion herein, any item card 1-11, A, B can be selected by a user 52 on the digital advertising content communications device 116 through a swipe and/or button press, where such selection can activate the item card 1-11, A, B in a number of different manners. To set forth just one example, selecting an item card 1-11, A, B through a button push can be used to expand the selected item card 1-11, A, B to a larger size, such as, for example, from a 1x1 size to a 3x3 size, if not already 3x3. Such increase in size and also be accompanied by additional information for the selected product becoming viewable. In another non-limiting example, item card 1-11, A, B can be added to a shopping list through a button push or swiping on the item card 1-11, A, B.

The memory of the digital advertising content communications device 116 can include instructions that, when executed by the processor 225, cause the processor 225 to present updates to the digital layout grid, as provided to the digital advertising content communications device 116, such as, for example, via the channel 72. Such updates can include updates and/or changes in the product(s) and/or product content shown in the digital circular 105 via one or more of the item cards 1-11, and/or changes in the spatial position of one or more, if not all, of the item cards 1-11 in digital layout grid 117.

The back end system 70 can generate a link using a unique extension added to a uniform resource locator (URL) for a given retailer, or specific retailer location, to provide the ability for that retailer to view a proof of the content and/or digital circular 105 that will be published in the future. The back end system 70 can also be configured to allow a retailer to show an advertising partner proof of performance by sharing a link to view what was published in the past, including viewing prior content for one or more products associated with that CPG/Vendor and/or previous versions of the digital circular 105. Such a URL can also be coded with an additional unique extension. For example, the URL used for a particular retailer can have a numeric extension added indicated the date and/or date range that particular content was made available to users 52 via the digital circular 105.

The detailed discussion above related to the spatial positioning and dynamic content of a plurality of circular items positioned on a digital circular based on item card parameters may be applied to the generation of digital circulars with item cards specific to the location of the user relative to different locations of the digital retailer including items that may be discounted at the time the user is within a distance of the different locations of the digital retailer as compared to competitors at the time the user is within the distance of the different competitor locations discussed in detail below in which the item card parameters are indicative to a presentation of each item card displayed in the digital circular and are customized to a priority of a digital circular associated with the digital circular location to advertise to the user. The priority may be based on a purchase priority of the user, a retailer priority, a priority of the product and/or any other priority discussed in detail above of each item card as displayed in the digital circular disclosed in detail above and may be applied to the digital circular displayed to the user based on the location of the user within the distance of the different locations of the digital retailer and/or the distance of the different competitor locations discussed in detail below.

For example, the dynamic formatting of each item card in an item card position and item card size to prioritize the display of each card on the digital circular based on item card parameters in which each item card that is dynamically formatted with item card content to dynamically display each item card content as spatially positioned in the digital circular grid to prioritize the display of the item card content based on a current state of the item card parameters as discussed in detail above may be applied to the digital circular displayed to the user based on the location of the user within the distance of the different locations of the digital retailer and/or the distance of the different competitor locations discussed in detail below.

Further, the dynamic formatting of each item card in an item card position and an item card size associated with each item card partition to prioritize the display of each item card in the digital circular based on the item card parameters to display in real-time in which each item card is dynamically formatted with item card content to dynamically display each item card with the item card with the item card content as spatially positioned in the digital circular grid to prioritize the display of the item card content based on a current state of the item card parameters as discussed in detail above may be applied to the digital circular displayed to the user based on the location of the user within the distance of the different locations of the digital retailer and/or the distance of the different competitor locations discussed in detail below. Further, the dynamic receiving of updates to the item card parameters associated with each corresponding item card that are updated based on the selections by the digital circular retailer, the user, and/or any combination thereof as discussed in detail above in which the item card changes as the corresponding item card parameters associated with each item card change as discussed in detail above may be applied to the digital circular displayed to the user based on the location of the user within the distance of the different locations of the digital retailer and/or the distance of the different competitor locations discussed in detail below.

Further, the dynamic adjusting the digital circular grid to display updates to each item card included in the digital circular grid and integrate the updated item card parameters as triggered by the selections made by the digital circular retailer, the user, and/or any combination thereof thereby triggering a change to the item card content displayed and a change in size and spatial position as each item card as displayed is dynamically adjusted based on the content of each item card and the item card parameters associated with each item card are updated as triggered by the selections of the digital circular retailer, user, and/or any combination thereof as discussed in detail above may be applied to the digital circular displayed to the user based on the location of the user within the distance of the different locations of the digital retailer and/or the distance of the different competitor locations discussed in detail below.

### Location-based Notifications for Dynamic Digital Advertising Content

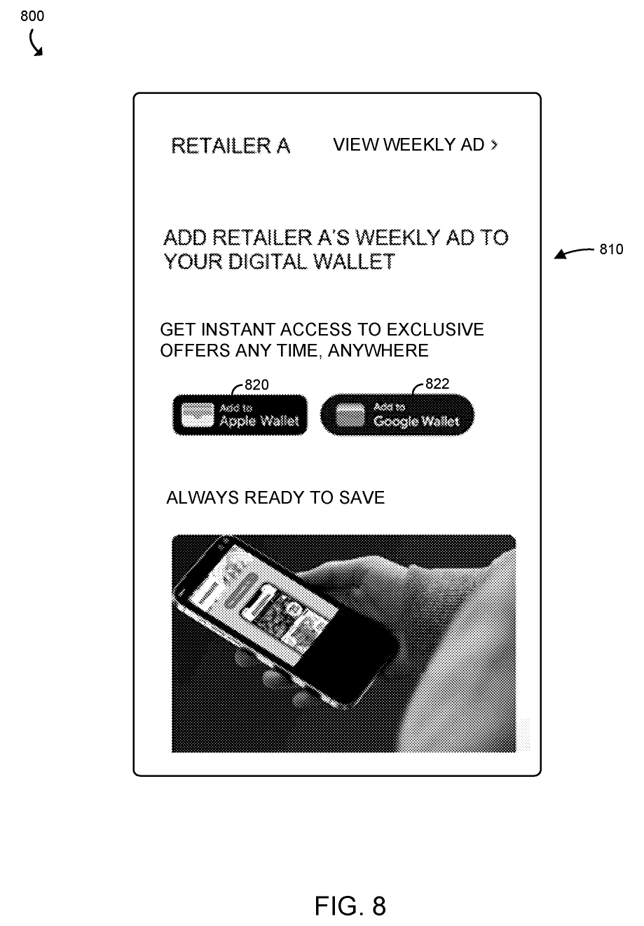

Referring now to FIG. 8, the DDACS 50, and in particular, a dynamic digital advertising content communications device 116, 220 may be configured to obtain executable code encapsulated in (e.g., packaged or formatted as) a digital wallet card configured for a digital wallet of the dynamic digital advertising content communications device 116, 220. In some embodiments, the dynamic digital advertising content communication device 116, 220 may scan (e.g., take a picture of, using an imaging device, such as a camera) a visual code, such as a quick response code (QR code) or other two-dimensional or one dimensional bar code, that encodes a network location (e.g., a uniform resource locator (URL)). Upon scanning the visual code with the network location, or in response to a request from a user (e.g., by selecting a corresponding link in a web page, in response to the user typing in the network location, etc.), the dynamic digital content communication device 116, 220 may load and render a web page or other set of content in a user interface 800, offering the option to download a corresponding digital wallet card to a digital wallet of the dynamic digital content communication device 116, 220. The digital wallet may be, for example, Apple Wallet that is preconfigured on an Apple iPhone, Google Wallet for Android-based smartphones, Samsung Wallet for smart phones manufactured by Samsung Electronics, or the like. Each digital wallet is configured to enable digital payments using corresponding payment cards that have been formatted or packaged as digital wallet cards. Additionally, each digital wallet may enable tracking and management of information associated with other cards, such as membership cards for gymnasiums, parks, or the like, tickets for events, and/or other items that enable a user to access a location, product, or service and which may otherwise be embodied as a physical card carried by the user.

As shown in FIG. 8, the user interface 800 presented by the dynamic digital advertising content communications device 116, 220 includes a description 810 of the digital wallet card and options 820, 822 to add the digital wallet card to a digital wallet (e.g., Apple Wallet or Google Wallet). The digital wallet card, as explained in the description, enables instant access to exclusive offers, in the form of dynamic digital advertising content, associated with a particular retailer. For example, in at least some embodiments, the dynamic digital advertising content is a weekly advertisement indicating one or more special promotions for product(s) sold by the retailer.

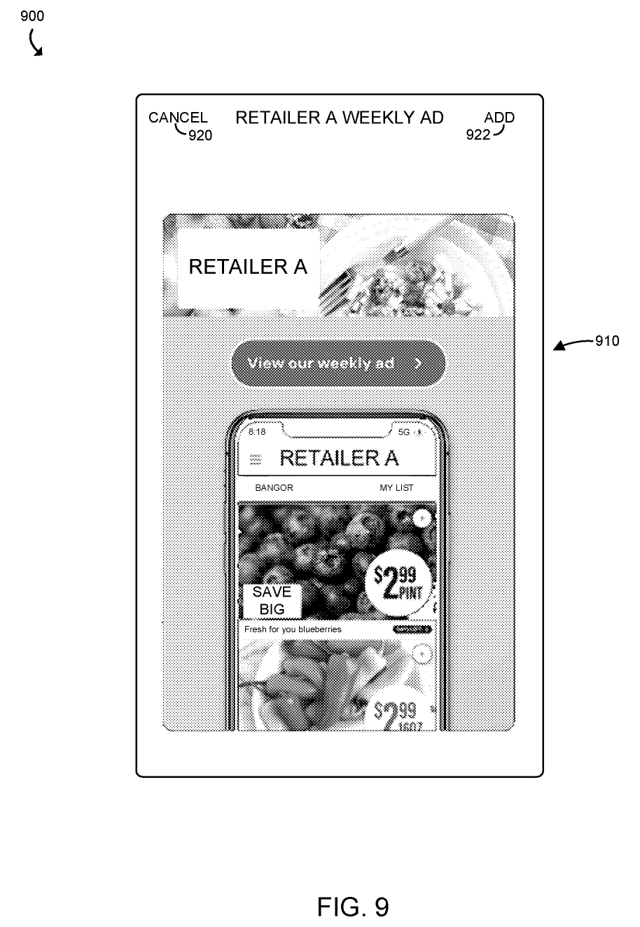

In response to detecting that the user selected one of the options 820, 822, the dynamic digital advertising content communications device 116, 220 may execute an operation associated with the digital wallet to display a user interface 900 in FIG. 9. The user interface 900 includes a graphic 910 associated with the digital wallet card along with an option 920 to cancel the process of adding the digital wallet card to the digital wallet and an option 922 to proceed with adding the digital wallet card to the digital wallet. In response to a determination that the user has selected the option 922, the dynamic digital advertising content communications device 116, 220 installs the corresponding digital wallet card.

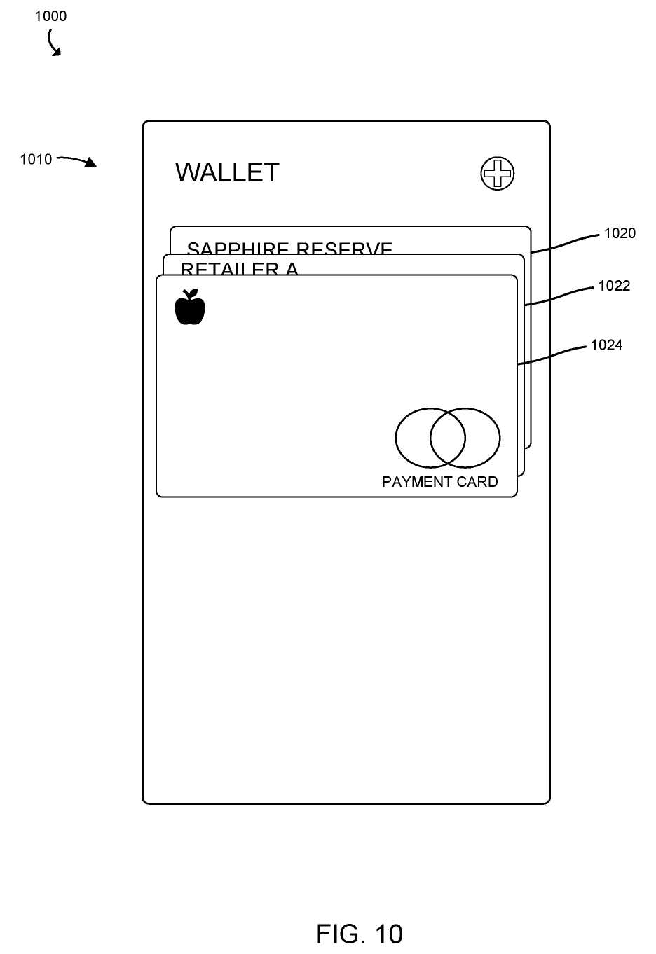

Referring now to FIG. 10, the dynamic digital advertising content communications device 116, 220 may present a user interface 1000, indicative of the digital wallet 1010, such as in response to the user selecting the option 922 and/or in response to the user opening the digital wallet 1010 at a later time. The user interface 1000 includes a set of digital wallet cards 1020, 1022, 1024. Among the digital wallet cards 1020, 1022, 1024, are two digital wallet cards 1020, 1024 corresponding to payment cards (e.g., credit cards) that were added to the digital wallet 1010 separately from the process described above with respect to FIGS. 8, 9, and the digital wallet card 1022 associated with the retailer, which was added to the digital wallet 1010 in accordance with the process described above.

Unlike other applications installed to the dynamic digital advertising content communications device 116, 220, services for location tracking and presenting notifications associated with the digital wallet 1010 and the digital wallet cards (e.g., the digital wallet card 1024) within the digital wallet 1010 are enabled by default. That is, the user need not affirmatively enable location tracking or notifications in a set of configuration settings of the dynamic digital content communication device 116, 220 to allow the digital wallet 1010 or digital wallet cards in the digital wallet to perform location tracking operations, such as accessing and utilizing corresponding hardware, such as a global position system (GPS) receiver, of the dynamic digital advertising content communications device 116, 220 or displaying notifications on a display of the dynamic digital advertising content communications device 116, 220. A notification may be embodied as any message that may be displayed by the digital advertising content communications device 116, 220 to notify a user of corresponding information, even when the software application associated with the notification is not actively displayed by the digital content communication device 116, 220. That is, a notification may be displayed on a home screen, a lock screen, or other user interface that does not represent a user interface of the corresponding application or process responsible for the notification.

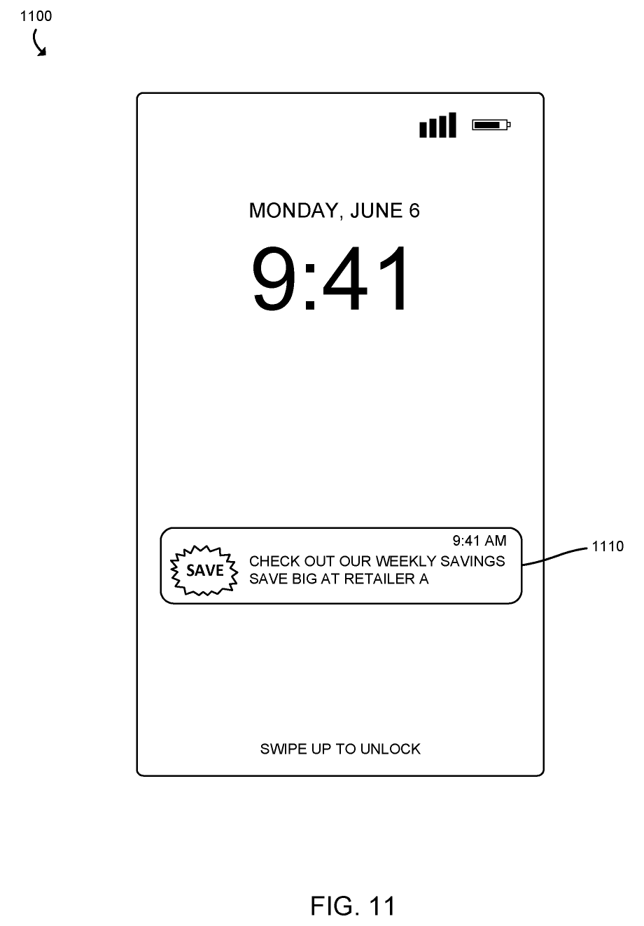

Referring now to FIG. 11, the dynamic digital advertising content communications device 116, 220 may display a notification 1110 in a user interface 1100. In the illustrative embodiment, the user interface 1100 is a lock screen, which is a user interface that displays limited information and features and prevents unauthorized access to most features of the dynamic digital content communication device 116, 220 by requiring authentication credentials, such as a PIN, a password, biometric authentication credentials, or the like before enabling access to such features. The notification 1110 includes a message prompting the user to view corresponding digital advertising content associated with the retailer that is associated with the digital wallet card 1022. As described in more detail herein, the digital wallet card 1022 causes the dynamic digital advertising content communications device 116, 220 to continually determine the present location of the dynamic digital content communications device 116, 220 compare the present location to each of a set of geographic locations defined by the retailer and stored in the memory of the dynamic digital advertising content communications device 116, 220 in association with the digital wallet card 1022 to determine whether the dynamic digital advertising content communications device 116, 220 is at or within one of those defined geographic locations, and if so, present a corresponding notification (e.g., the notification 1110) prompting the user to view dynamic digital advertising content associated with the retailer.

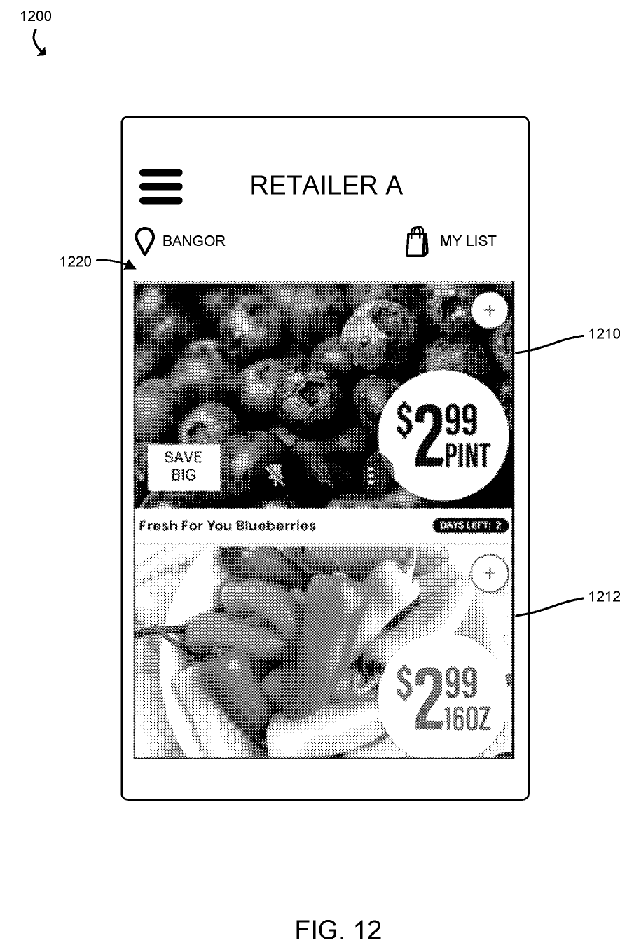

Referring now to FIG. 12, in response to determining that the user selected the notification 1110, the dynamic digital advertising content communications device 116, 220, in the illustrative embodiment, displays the corresponding dynamic digital advertising content 1220, such as in the user interface 1200. As shown, the dynamic digital advertising content includes promotions 1210, 1212 for corresponding products sold by the retailer. Each promotion 1210, 1212 may be embedded in a corresponding item card and may be subject to dynamic rendering in connection with the item card parameters, as described above. In some embodiments, the dynamic digital advertising content is embedded in a web page associated with a particular store location of the retailer (e.g., to provide hyperlocal content, as described above).

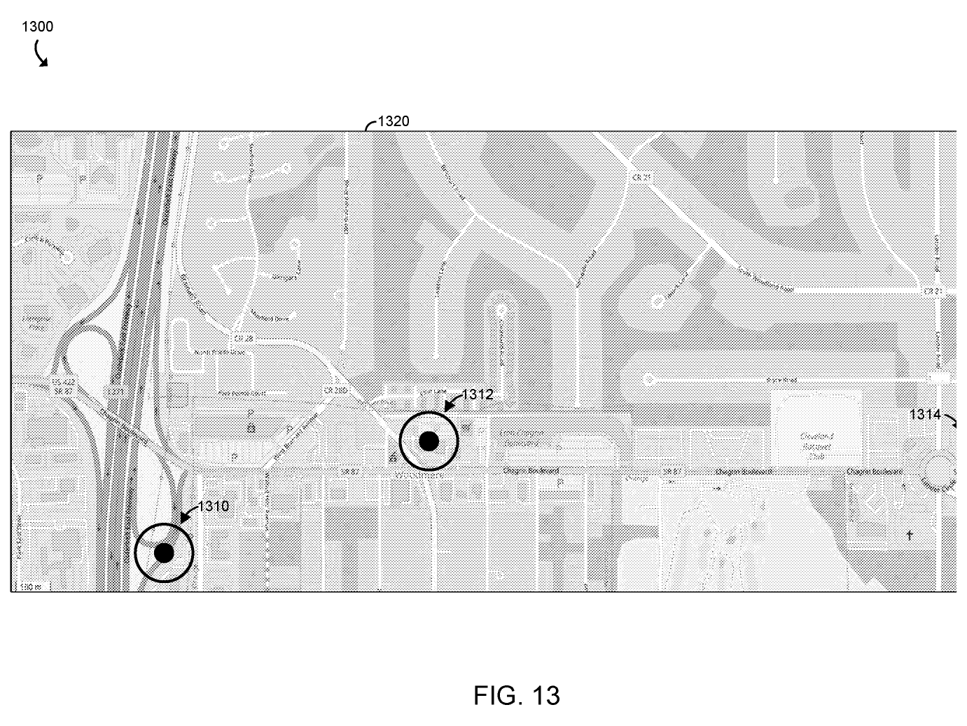

Referring now to FIG. 13, the retailer, using the DDACS 50, such as a retailer portal, may define a set of geographic locations 1310, 1312, 1314 that, when a corresponding dynamic digital advertising content communications device 116, 220 is at or within the geographic location 1310, 1312, 1314, cause a corresponding notification (e.g., the notification 1110) to be presented by that dynamic digital advertising content communications device 116, 220. Each geographic location may be defined as a set of coordinates, such as latitude and longitude coordinates. Further, each geographic location 1310, 1312, 1314 may be associated with a corresponding radius to represent an area, rather than a single point. In at least some embodiments, the DDACS 50 may present a user interface 1300 representing a map 1320 that enables the retailer to easily select points on the map 1320 at which each geographic location 1310, 1312, 1314 is to be defined. When the geographic locations 1310, 1312, 1314 are defined, the DDACS 50, in the illustrative embodiment, encodes those geographic locations in a data set to be utilized by the corresponding digital wallet card 1022. To do so, the digital wallet integration 90 may encode those geographic locations in the executable instructions encapsulated (e.g., formatted, packaged) as the digital wallet card 1022, and provide the same to the dynamic digital advertising content communications device 116, 220 in accordance with the process described above, relative to FIGS. 8-9. Additionally or alternatively, the DDACS 50, and in particular, the digital wallet integration 90, may provide data indicative of the geographic locations after the digital wallet card 1022 has been added to the digital wallet 1010, such as in an update transmitted over a corresponding network connection.

In some embodiments, as described in more detail herein, each geographic location 1310, 1312, 1314 may cause a different notification to be displayed and/or may be associated with a network address from which the dynamic digital advertising content communications device 116, 220 is to request the corresponding dynamic digital advertising content. For example, each geographic location 1310, 1312, 1314 may be associated with a tag (e.g., a set of numbers, characters, and/or other symbols) that may be added to a base network address (e.g., URL) to be included in a request from the dynamic digital advertising content communications device 116, 220 in response to a detection that the user selected the corresponding notification. By utilizing different network addresses per geographic location (and per corresponding notification), the DDACS 50 may identify which geographic location triggered the corresponding notification that caused the user to decide to view the corresponding dynamic digital advertising content (e.g., special promotions, such as in a weekly advertisement). Similarly, to further enable analytics by the DDACS 50, the dynamic digital advertising content communications device 116, 220 may add an identifier of the dynamic digital advertising content communications device 116, 220 as a tag in the network address, to enable the DDACS 50 to differentiate requests from different dynamic digital advertising content communications devices 116, 220 and to identify patterns in behaviors of users of those dynamic digital advertising content communications devices 116, 220. Importantly, in at least some embodiments, the unique identifier does not include personally identifiable information and the digital wallet card does not require a user registration or authentication process in order to utilize the digital wallet card (e.g., to install it to the digital wallet 1010, to receive corresponding notifications, and to view the corresponding dynamic digital advertising content).

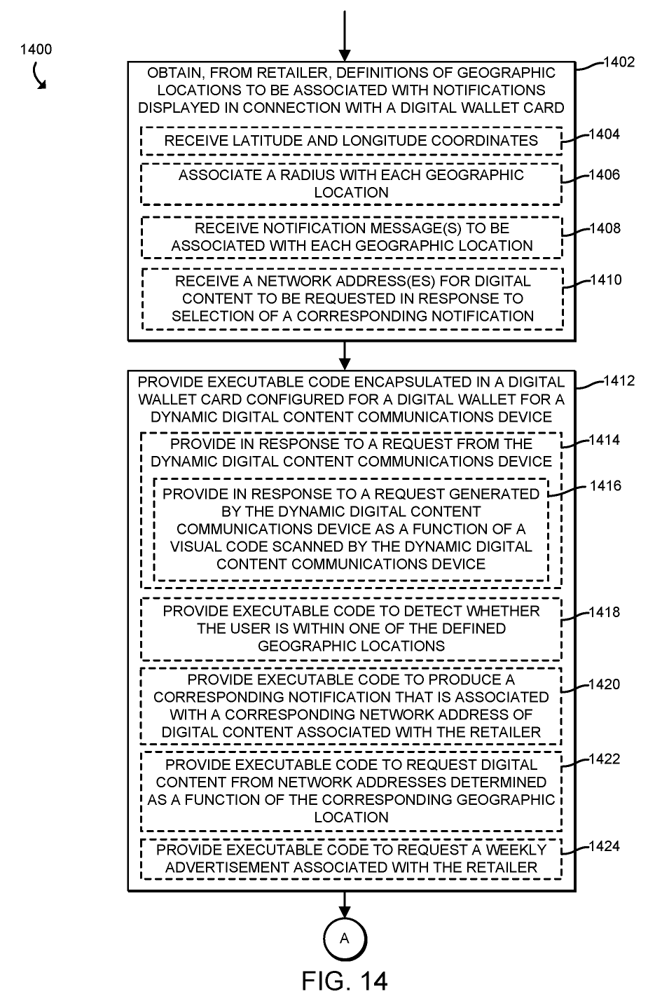

Referring now to FIG. 14, the DDACS 50 may perform a method 1400 for providing location-based notifications to view dynamic digital advertising content. The method 1400, in the illustrative embodiment, begins with block 1402 in which the DDACS 50 obtains, from a retailer, definitions of geographic locations to be associated with notifications that are to be displayed in connection with a digital wallet card. In doing so, the DDACS 50 may receive latitude and longitude coordinates for each geographic location, as indicated in block 1404. As described above, the DDACS 50 may receive the geographic locations via a user interface 1300, which may be embodied as a map 1320 on which the retailer may define the geographic locations (e.g., by selecting corresponding locations on the map 1320). The retailer may provide the information through a corresponding portal, such as the client portal 128, which is communicatively connected to the back end 70, which in turn, is connected to the digital wallet integration 90.

In block 1406, the DDACS 50 may associate a radius with each geographic location defined by the retailer. In doing so, the DDACS 50 may associate a predefined radius, such as 500 feet, or another predefined or default radius. In some embodiments, the DDACS 50 may prompt the retailer to enter the radius and may utilize the default radius if the retailer does not provide a different radius in response to the prompt. The DDACS 50, in some embodiments, may define the radius as a function of a complexity or density of the geographic area in which the geographic location is defined. For example, if the geographic location is near a set of parallel roads, one of which includes an exit that leads to the location of the retailer’s store and another that does not have such an exit, the DDACS 50 may constrict the area of the geographic location by reducing the radius to prevent the corresponding dynamic digital advertising communications device 116, 220 from presenting the notification if the user is traveling along the road that does not have the exit that leads to the retailer’s store. In other embodiments, rather than or in addition to defining each geographic location as a circular area defined by a point (e.g., corresponding to latitude and longitude coordinates) and a corresponding radius, the DDACS 50 may enable the retailer to define one or more geographic locations by a rectangular boundary or other shape, which may be an irregular shape.

Further, in block 1408, the DDACS 50 may receive a set of notification messages, defined by the retailer, to be associated with notifications associated with the geographic locations. In some embodiments, the DDACS 50 may receive a different notification message to be associated with each of the geographic locations defined by the retailer. For example, one geographic location 1312 may be the location of the retailer’s store 1312 and the retailer may define the corresponding notification message to include a welcome message, welcoming the user to the store and inviting the user to view the dynamic digital advertising content (e.g., promotions for products). Separately, another geographic location 1310 may correspond with a highway exit and the retailer may define the corresponding notification message to include a direction and/or distance from the retailer’s store (e.g., half a mile east from the highway exit) and inviting the user to view the dynamic digital advertising content. As yet another example, a geographic location 1314 may correspond with the location of a competitor retailer and the retailer using the DDACS 50 may define the notification message to include text informing the user that the retailer’s store is nearby (e.g., one mile west) and inviting the user to view dynamic digital advertising content. The DDACS 50, in some embodiments, may suggest one or more of the geographic locations and/or notification messages, such as based on analytics indicative of identified patterns in consumer behavior, types of geographic locations (e.g., highway exits, entrances to stores, etc.) determined to result in relatively high amounts of views of corresponding digital advertising content, or the like, as described in more detail herein.

The DDACS 50 may receive network addresses (e.g., URLs) for digital content (e.g., dynamic digital advertising content) to be requested by the dynamic digital advertising content communication device 116, 220 in response to detecting that the user selected a corresponding notification, as indicated in block 1410. In some embodiments, each notification and corresponding geographic location may be associated with a different network address (e.g., URL). In other embodiments, the network address is constant across the notifications. In some embodiments, the network address (e.g., URL) includes a placeholder for a tag indicative of the corresponding geographic location that triggered the notification. As described herein, by varying the network address as a function of the corresponding notification and geographic location that the notification is based on, when the corresponding dynamic digital advertising content communications device 116, 220 submits the request via a network connection (e.g., to the DDACS 50), the DDACS 50 may identify the geographic location that formed the basis of the request and record that information for use in analytics operations.

Continuing the method 1400, in block 1412, the DDACS 50 provides executable code that is encapsulated (e.g., packaged, formatted, etc.) as a digital wallet card configured for a digital wallet for a dynamic digital advertising content communications device 116, 220. In at least some embodiments, the digital wallet integration 90 described above provides the executable code encapsulated as a digital wallet card to the dynamic digital advertising content communications device. In doing so, the DDACS 50 may provide the executable code in response to a corresponding request from the dynamic digital advertising content communications device 116, 220, as indicated in block 1414. For example, and as indicated in block 1416, the DDACS 50 may provide the executable code in response to a request that was generated by the dynamic digital advertising content communications device 116, 220 as a function of a visual code scanned by the dynamic digital advertising content communications device 116, 220, such as with a camera. The visual code, may, in some embodiments, be a barcode or QR code printed in an advertisement from the retailer and/or on display at the retailer’s store.

In the illustrative embodiment, in block 1418, the DDACS 50 (e.g., the digital wallet integration 90) provides executable code to cause the dynamic digital advertising content communications device 116, 220 to detect whether the user is within one of the defined geographic locations from block 1402. In the illustrative embodiment, and as described elsewhere herein, the executable code may utilize location services (e.g., which may utilize location determination hardware in the dynamic digital advertising content communications device 116, 220, such as a GPS receiver) to determine the location of the dynamic digital advertising content communications device 116, 220, and by implication, the user of the dynamic digital advertising content communications device 116, 220 continually. As described above, by encapsulating the executable code in a digital wallet card to be executed in connection with the digital wallet of the dynamic digital advertising content communications device 116, 220, the location services are automatically enabled and are not reliant on the user affirmatively enabling those services, unlike other software applications that may be installed on the dynamic digital advertising content communications device 116, 220.

In providing the executable code, the DDACS 50 (e.g., the digital wallet integration 90) provides executable code to produce a corresponding notification that is associated with a corresponding network address of digital content (e.g., dynamic digital content, such as a weekly advertisement or other promotion) associated with the retailer, in block 1420. Similar to the location services, the notification services are automatically enabled on the dynamic digital advertising content communications device 116, 220 for the digital wallet and any digital wallet cards associated with the digital wallet. Accordingly, the user need not affirmatively enable notifications associated with the executable code provided in connection with the digital wallet card of the retailer.

The DDACS 50, in the illustrative embodiment, provides executable code to request digital content from network addresses that are determined as a function of the corresponding geographic location that served as the basis for triggering the corresponding notification, as indicated in block 1422. As described above, the retailer may define a different network location in association with each defined geographic location, may define a single network location with a placeholder for a tag associated with each geographic location, or may utilize the same network location for each geographic location. Further, as described above, by varying the network location as a function of the corresponding geographic location that served as a basis for the corresponding notification, the DDACS 50 may perform enhanced analytics that provides insights into which geographic location served as the trigger for causing the user to view the corresponding digital advertising content requested from the DDACS 50 (based on a corresponding network address in the request). In some embodiments, as indicated in block 1424, in providing the executable code, the DDACS 50 provides executable code that causes the dynamic digital advertising content communications device 116, 220 to request a weekly advertisement from the corresponding retailer (e.g., the network request defined in association with the geographic locations and notifications is an address of a weekly advertisement associated with the retailer).

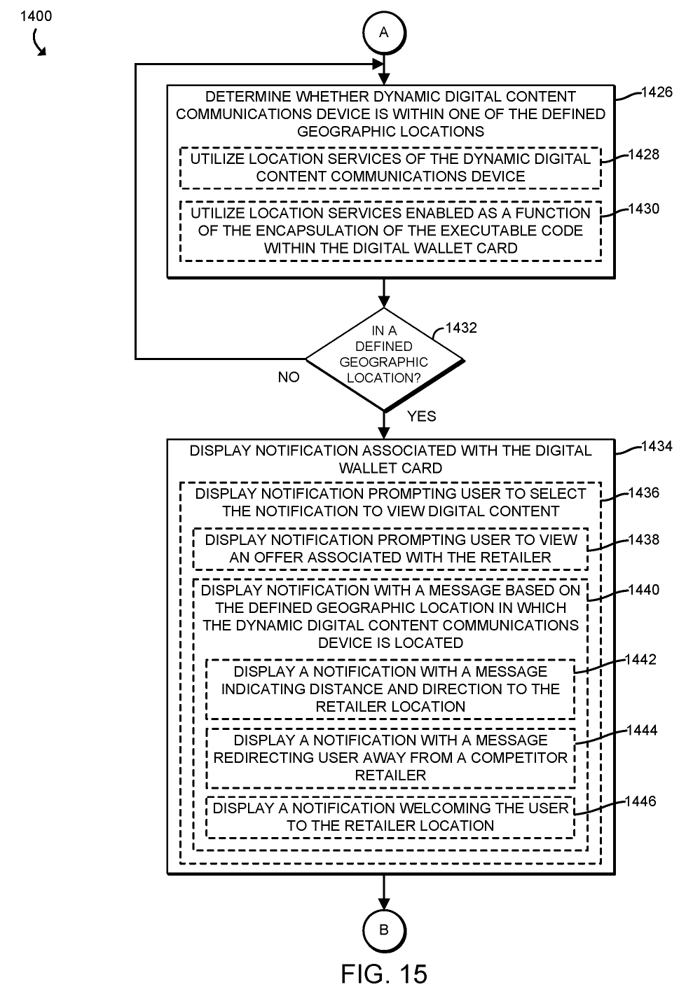

Continuing the method 1400, in block 1426 of FIG. 15, the DDACS 50, and in particular, the dynamic digital advertising content communications device 116, 220 determines whether the dynamic digital advertising content communications device 116, 220 is within one of the defined geographic locations. In doing so, in block 1428, the dynamic digital advertising content communications device 116, 220 utilizes the location services of the dynamic digital advertising content communications device 116, 220. As indicated in block 1430, the dynamic digital advertising content communications device 116, 220 uses the location services, which are enabled as a function of the encapsulation of the executable code within the digital wallet card. That is, the location services are available to the executable code due to the executable code being associated with a digital wallet card. In at least some embodiments, the dynamic digital advertising content communications device 116, 220 utilizes location tracking hardware, such as a GPS receiver, to determine the position of the dynamic digital advertising content communications device 116 and compare that position to each of the defined geographic locations.

In block 1432, the DDACS 50, and in particular, the dynamic digital advertising content communications device 116, 220, determines the subsequent course of action based on whether the dynamic digital advertising content communications device 116, 220 was determined to be within one of the defined geographic locations. If not, the method 1400 loops back to block 1426 to again determine whether the dynamic digital advertising content communications device 116, 220 is within one of the defined geographic locations. That is, the dynamic digital advertising content communications device 116, 220 may continually re-determine whether the dynamic digital advertising content communications device 116, 220 is within one of the defined geographic locations. In response to a determination that the dynamic digital advertising content communications device 116, 220 is within one of the defined geographic locations, the method 1400 advances to block 1434, in which the DDACS 50, and in particular, the dynamic digital advertising content communications device 116, 220, displays a notification associated with the digital wallet card (e.g., the digital wallet card 1022).

In displaying a notification, the DDACS 50, and in particular, the dynamic digital advertising content communications device 116, 220 may display a notification that prompts the user to select the notification to view digital content (e.g., dynamic digital advertising content), as indicated in block 1436. For example, in some embodiments, the dynamic digital advertising content communications device 116, 220 may display a notification that prompts the user to view an offer associated with the retailer, as indicated in block 1438. As described above, FIG. 11 depicts a notification 1110 that may presented by the dynamic digital advertising content communications device 116, 220 with a message that prompts the user to view an offer associated with the retailer. In some embodiments, the dynamic digital advertising content communications device 116, 220 may display a notification with message that is based on the defined geographical location in which the dynamic digital advertising content communications device 116, 220 is located, as indicated in block 1440. Each of those notification messages may be defined by the retailer, such as through the client portal 128, as described above. In block 1442, the dynamic digital advertising content communications device 116, 220 may display a notification with a message indicating a distance and direction to the retailer location (e.g., the retailer’s store). Such a notification may, for example, indicate that the retailer’s store is half a mile east from the highway exit that the dynamic digital advertising content communications device 116, 220 is presently located at (e.g., the geographic location 1310 in FIG. 13).

As indicated in block 1444, the dynamic digital advertising content communications device 116, 220 may display a notification with a message redirecting the user away from a competitor retailer. The dynamic digital advertising content communications device 116, 220 may display such a notification in response to a determination that the dynamic digital advertising content communications device 116, 220 is presently at a defined geographic location associated with a competitor retailer (e.g., the geographic location 1314). The notification may include information about the distance and direction to the retailer’s store (e.g., one mile west). As indicated in block 1446, the dynamic digital advertising content communications device 116, 220 may display a notification welcoming the user to the retailer location, such as in response to a determination the dynamic digital advertising content communications device 116, 220 is at the geographic location 1312. Each of the above notification messages, in the illustrative embodiment, include a prompt for the user to select the notification to view dynamic digital advertising content associated with the retailer.

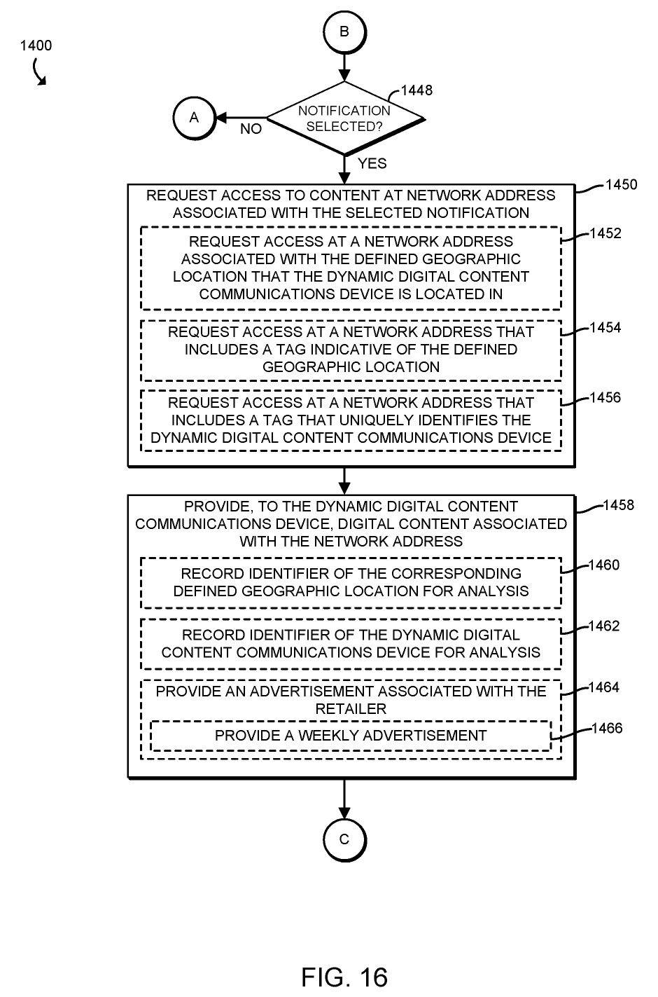

Referring now to FIG. 16, in block 1448, the dynamic digital advertising content communications device 116, 220 determines whether the user selected the displayed notification. In response to a determination that the user did select the displayed notification, the method 1400 advances to block 1450 in which the dynamic digital advertising content communications device 116, 220 requests access to content (e.g., dynamic digital advertising content) associated with the selected notification. As described above, when setting up the digital wallet card (e.g., through the portal 128) the retailer may define a network address (e.g., URL) from which the dynamic digital advertising content communications device 116, 220 is to request content in response to user selection of a notification generated by the digital wallet card. In block 1452, the dynamic digital advertising content communications device 116, 220 may request access at a network address that is associated with the defined geographic location that the dynamic digital advertising content communications device 116, 220 is presently located in (e.g., the location that triggered the presentation of the notification). As described above, each notification and each corresponding geographic location may have a corresponding defined network address (e.g., defined by the retailer) and encoded in the executable instructions and/or data utilized by the associated digital wallet card.

In some embodiments, in block 1454, the dynamic digital advertising content communications device 116, 220 may request access to the content (e.g., the dynamic digital advertising content) at a network address that includes a tag that is indicative of the defined geographic location 1310, 1312, 1314 that triggered the notification selected by the user. That is, the dynamic digital advertising content communications device 116, 220 may utilize a base network address (e.g., URL) and append a tag indicative of the corresponding defined geographic location to that network address (e.g., URL) in generating the request for the corresponding content. The dynamic digital advertising content communications device 116, 220, in some embodiments, may request access at a network address that includes a tag that uniquely identifies the dynamic digital content communication device, as indicated in block 1456. That is, the dynamic digital advertising content communications device 116, 220 may append a tag with a code that is associated with the digital wallet card, such as a unique code embedded into a data set associated with the digital wallet card when the digital wallet card was obtained by the dynamic digital advertising content communications device 116, 220, in block 1412. In other embodiments, the tag may be a hardware-related code, such as a serial number, IMEI (International Mobile Equipment Identity) number, or the like, that may be appended to the network address. In other embodiments, the tag may be based on another set of information that is unique to the particular dynamic digital advertising content communications device 116, 220.

In block 1458, the DDACS 50 provides, to the dynamic digital advertising content communications device 116, 220, the content (e.g., the dynamic digital advertising content) associated with the network address (e.g., from the request in block 1450). In doing so, the DDACS 50 may record an identifier of the corresponding defined geographic location, which is specified in the network address in the request from the dynamic digital advertising content communications device 116, 220, as indicated in block 1460. Doing so may facilitate the performance of analysis operations on the effectiveness of the notifications and the geographic locations defined by the retailer, as described in more detail. In block 1462, the DDACS 50 may record an identifier of the dynamic digital advertising content communications device 116, 220 that requested the content. As described above, the identifier may be encoded as a tag that is included to the network address (e.g., URL) utilized by the dynamic digital advertising content communications device 116, 220 in the request from block 1450. In response to the request, the DDACS 50 may provide an advertisement (e.g., dynamic digital advertising content) associated with the retailer, as indicated in block 1464. For example, and as indicated in block 1466, the DDACS 50 may provide a weekly advertisement associated with the retailer. The advertisement may indicate special discounts or pricing on one or more products sold by the retailer.

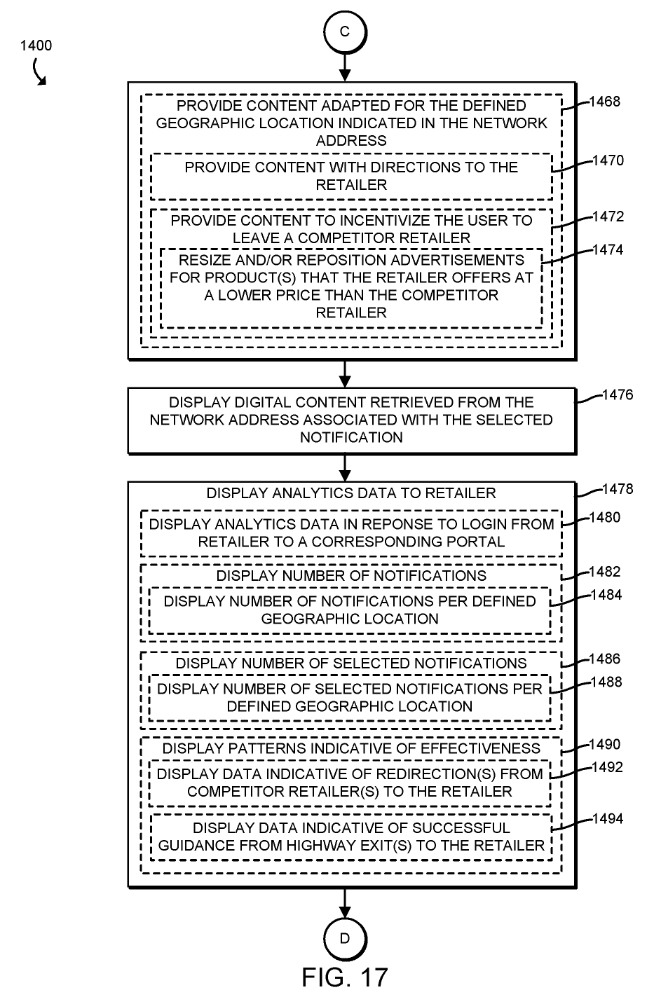

Referring now to FIG. 17, in response to the request, the DDACS 50 may, in some embodiments, provide content that is adapted for the defined geographic location that triggered the notification selected by the user and that is indicated in the network address used by the dynamic digital advertising content communications device 116, 220 in making the request for the content, as indicated in block 1468. In doing so, the DDACS 50 may provide content that includes directions to the retailer (e.g., to the retail store, such as at the geographic location 1312 in FIG. 13), as indicated in block 1470. In some embodiments, the DDACS 50 may provide content to incentivize the user to leave a competitor retailer, as indicated in block 1472. In doing so, the DDACS 50 may resize and/or reposition one or more advertisements for one or more products that the retailer offers at a lower price than the competitor retailer, as indicated in block 1474. That is, the DDACS 50 may adjust the item card parameters, as described above, to alter the presentation of the digital advertising content to fit the scenario indicated by the information provided in the network address utilized in the request for the content.

Continuing the method 1400, in block 1476, the DDACS 50, and in particular, the dynamic digital advertising content communications device 116, 220 displays the digital content (e.g., the dynamic digital advertising content) associated with the selected notification, and provided to the dynamic digital advertising content communications device 116, 220 in block 1458. Because the dynamic digital advertising content is presented to the user at a time that is controlled by the DDACS 50 and the retailer (e.g., in response to a determination that the user is at a location in which the digital advertising content may be more readily utilized by the user), the user may be more likely to take advantage of special promotions indicated in the dynamic digital advertising content (e.g., the weekly advertisement). As such, the DDACS 50 may enhance engagement between consumers and the retailer, drive increased traffic to locations of the retailer (e.g., retailer stores), and improve the retailer’s sales.

In some embodiments, the DDACS 50 may provide analytics data to the retailer, as indicated in block 1478. The DDACS 50 may provide the analytics data through the portal 128 (e.g., in a corresponding user interface presented to the retailer), in response to detecting that the retailer has logged in to the portal, as indicated in block 1480. In displaying the analytics data, the DDACS 50 may display analytics data indicative a number of notifications generated and presented in connection with the digital wallet card, as indicated in block 1482. In some embodiments, the DDACS 50 may display the number of notifications that were generated and displayed for each defined geographic location, as indicated in block 1484. Each dynamic digital advertising content communications device 116, 220 configured with the digital wallet card may anonymously report such information to the DDACS 50 on a periodic basis.

The DDACS 50, in displaying analytics data, may display the number of selected notifications across dynamic digital advertising content communications devices 116, 220 configured with the digital wallet card, as indicated in block 1486. Further, and as indicated in block 1488, the DDACS 50 may display the number of selected notifications per defined geographic location. Given that when a user selects a displayed notification, the dynamic digital advertising content communications devices 116, 220 submits a corresponding request for content to the DDACS 50, the DDACS 50 may readily track such statistics. Further, as described above, the request may include, in the network address, a tag indicative of the geographic location that gave rise to the notification that the user selected. As such, the DDACS 50 may readily track the specific geographic locations associated with the selected notifications and present that information as part of the analytics data.

Further, the DDACS 50 may display one or more patterns that are indicative of the effectiveness of the defined geographic locations defined by the retailer, as indicated in block 1490. The DDACS 50 may identify such patterns using the data collected from the requests, which may indicate the geographic location associated with each selected notification and may indicate a unique identifier associated with each of the dynamic digital advertising content communications devices 116, 220 in conjunction with the AI engine 80 described above. In doing so, in block 1492, the DDACS 50 may display data indicative of redirections from competitor retailers (e.g., from the geographic location 1314) to the retailer (e.g., to the geographic location 1312), which may be indicated by a sequence of notifications and associated selections of those notifications associated with those two locations 1314, 1312 from the same dynamic digital advertising content communications device 116, 220. Similarly, as indicated in block 1494, the DDACS 50 may display data indicative of successful guidance from a highway exit (e.g., the geographic location 1310) to the retailer (e.g. ,the geographic location 1312) based on a sequence of corresponding notifications and associated selections of those notifications from the same dynamic digital advertising content communications device 116, 220.

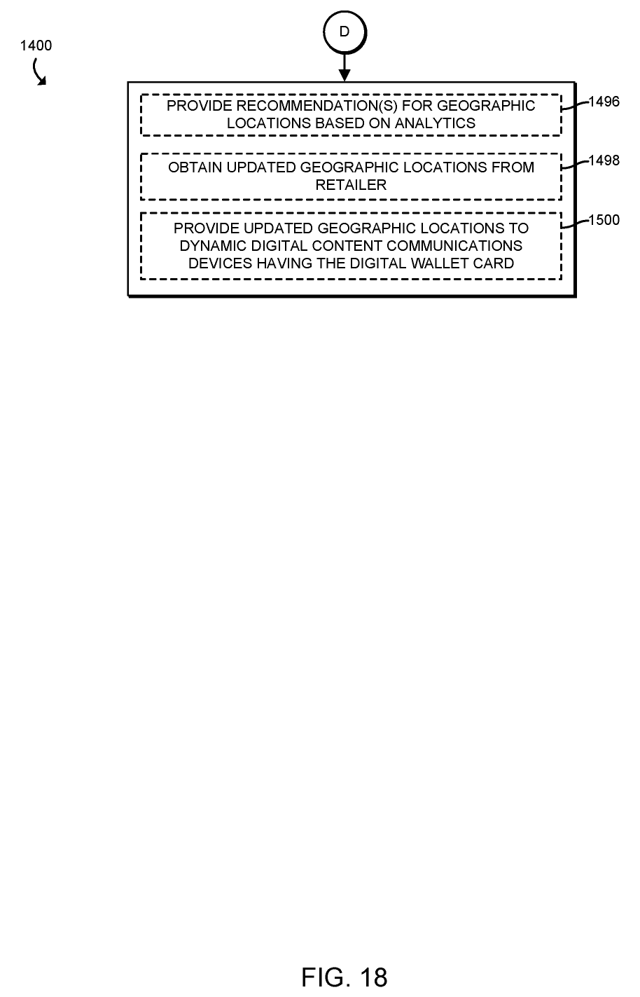

Referring now to FIG. 18, the DDACS 50 may provide one or more recommendations for geographic locations based on the analytics, as indicated in block 1496. In doing so, the DDACS 50 may compare analytics associated with the digital wallet card for the retailer against analytics associated with other digital wallet cards for other retailers and identify types of geographic locations that result in the highest numbers of notifications being selected by users, and may suggest those types of geographic locations to the present retailer, such as through the portal 128. As indicated in block 1498, the DDACS 50 may obtain updated geographic locations from the retailer (e.g., based on the recommendations from block 1496). The retailer may define the updated geographic locations by selecting locations on a map, such as in a user interface similar to the user interface 1300 of FIG. 13. Further, the DDACS 50 may provide the updated geographic locations to any dynamic digital advertising content communications devices having (e.g., that are configured with) the digital wallet card (e.g., the digital wallet card 1022) associated with the retailer, as indicated in block 1500. In doing so, the DDACS 50 may transmit the updated geographic locations from the digital wallet integration 90 to each dynamic digital advertising content communications device 116, 220 via a corresponding network connection.

### System Layout

With particular reference to the system layout 200 depicted FIG. 3, and with continued reference to FIG. 1, the DDACS 50 can use several different types of communication devices (e.g. 225, 210) connected through any suitable network 250. The system layout 200 has many similar features as that discussed above with respect to the DDACS 50; therefore, only the differences between the system layout 200 and the DDACS 50 are to be discussed in further detail immediately below.

The illustrated dynamic digital advertising content communications device 220, which can also be referred to as the user computing device 220, of a user 52, includes one or more processors 225, a memory(ies), and a user interface 260. Moreover, the user computing device 220 can be similar to the digital advertising content communications devices 116 discussed above with respect to at least FIG. 1 and 4. The user interface 260 can comprise various types of input devices and output devices, such as, for example, a screen, display, touch screen, keyboard, and/or mouse, as well as combinations thereof, among others.

The system can also include a computing device for the retailer, which is identified in FIG. 5 as a dynamic digital advertising content computing device 210, and which, for purposes of discussion, can be referred to as the retailer computing device 210. The retailer computing device 210 can include one or more processors 205, a memory(ies), and a retailer interface. Moreover, the retailer computing device 210 can be similar to the types of computing devices discussed above, including, for example, a computing device similar to the user computing device 220.

The computing devices 210, 220 are capable of interacting with each other via a network 250 and/or a dynamic digital advertising content server 230. In one form the dynamic digital advertising content server 230 is the back end system 70 depicted in FIG. 1. The computing devices 210, 220 can thus be used to initiate and/or receive transmissions through the network 250.

As illustrated in FIG. 3, the dynamic digital advertising content server 230 can further be coupled with an artificial intelligence system 240, which, in the illustrative embodiment includes a set of one or more artificial intelligence models 245. The artificial intelligence system 240 may include at least one processor and at least one memory, similar to the devices 210, 220, 230 and each of the artificial intelligence models 245 may be capable of being trained using input from a retailer or other user via the retailer computing device 210 and/or from information obtained from the dynamic digital advertising content server 230 (e.g. the back end system 70) to learn user 52 behaviors using information received from the digital advertising content communications device 220. According to certain embodiments, the set of artificial intelligence models 245 includes one or more of the artificial intelligence models discussed above with respect to the AI engine 80 and the personalization AI engine 100.

According to certain embodiments, the digital advertising content communications device 220 can generally continuously stream item card parameters to the dynamic digital advertising content server 230, which can be operated upon and/or stored in a database for further use. In doing so, the server 230 may continuously accumulate data. Over time as the data accumulated by the content server 230 continues to increase, the artificial intelligence system 240 (e.g., the previously discussed neural networks of the AI engine 80 and/or the personalization AI engine 100), may apply the data to the associated model(s) 245. In doing so, the artificial intelligence system 240 may apply the data to one or more machine learning algorithms to enable continued machine learning within the AI models 245. For example, the artificial intelligence system 240 can apply such data and information to one or more machine learning algorithms adapted for a multilayer perceptron (MLP), a restricted Boltzmann Machine (RBM), a convolution neural network (CNN), or other machine learning model architecture that will be apparent to those skilled in the relevant art(s) without departing from the spirit and scope of the disclosure.

According to certain embodiments, each time item card parameters are streamed to the content server 230, the artificial intelligence system 240 may assist the retailer computing device 210 by providing the retailer computing device 210 with an appropriate adjustment with regard to the appropriate item card parameters. Such an adjustment by the artificial intelligence system 240, which may be based on, for example, on the above-discussed predictions provided by the personalization AI engine 100, can accommodate each item card 1-11, and thus the associated dynamic digital advertising content, being dynamically formatted, including formatted based on predictions provided by the personalization AI engine 100 regarding the user 52 to which the item cards 1-11 will be viewed. Thus, such dynamic formatting can include the selection of which products are to be presented in the set of dynamic digital advertising content, the particular content for those products that is to be presented in the item card(s) 1-11, and/or the arrangement of the item cards 1-11 in the digital layout grid 117.

Again, the accuracy of the predictions of the artificial intelligence system 240, and the associated adjustments and/or selections for the formatting of the set of dynamic digital advertising content, can continue to improve as the artificial intelligence system 240 further learns or is furthered trained using the continued accumulation of data that is provided from the front end system 68 and/or the back end system 70. Thus, the accuracy and/or efficiency in terms of at least product sales and/or virtual traffic resulting from the determination of the item cards 1-11 that are displayed to the digital advertising content communications device 220 can be further enhanced by virtue of improving the accuracy of customization for each user 52 of the item cards 1-11 that are to be displayed in the set of dynamic digital advertising content on the digital advertising content communications device 220.

The neural network 240 may assist the retailer computing device 210 in learning as to the display of digital circular 105s based on the item card parameters to push to the front end system 68 based on learned attributes of the user such that artificial intelligence system 240 may further improve the success of any given promotion as displayed in set of dynamic digital advertising content that are customized and displayed for the user. For example, the artificial intelligence system 240 may receive updated item card parameters as the user 52 engages the digital advertising content communications device 220 such as, but not limited, to internet browsing activity of the user 52. In such an example, the item card parameters may be associated with products in the set of dynamic digital advertising content that are clicked by the user 52, via the user 52 computing device 220 as the user 52 conducts the internet browsing activity via digital advertising content communications device 220 in real-time. In real-time, item card parameters may be generated and/or adjusted as the user 52 engages the dynamic digital advertising content communications device 220. The artificial intelligence system 240 can be used to identify aspects of the user’s preferences through any one of many machine learning or artificial intelligence methodologies. To set forth one non-limiting example, the artificial intelligence system 240 can receive browsing activity as an input, and output product preferences. Browsing history includes such information as user 52 selections, via the communication device, of products of interest, number of selections, frequency of selections, time of day of selections, location of selections, etc. Such product preferences can be one of type of manufacturer and/or type of food stuff, where such output can be pushed to a particular user’s 52 set of dynamic digital advertising content, as displayed on the dynamic digital advertising content communications device 220, where the product preferences output from the artificial intelligence system 240 can be displayed. In some forms the artificial intelligence system 240 can also output recommended time of day for pushes of product recommendations. In another non-limiting form, the artificial intelligence system 240 can receive as input browsing activity of a plurality of users 52 across a plurality of retailer locations, and the artificial intelligence system 240 can be configured to output recommended products for display tied to any one or more of individual users or retailer locations.

The server 230 can include a processor, a memory, and a network interface. For example, the server 230 can include a data information system, data management system, web server, and/or file transfer server. The server 230 can also be a workstation, mobile device, computer, cluster of computers, set-top box, a cloud server or other computing device. In an embodiment, multiple modules may be implemented on the same server 230. Such a server 230 can also include software, firmware, hardware, or a combination thereof. Software may include one or more applications on an operating system. Hardware can include, but is not limited to, a processor, memory, and/or graphical user interface display.

As previously discussed, the digital advertising content communications device 220 is structured to display dynamic digital advertising content. The version of the dynamic digital advertising content that the user 52 is to receive can, for example, be at least partially based on a current time frame that the dynamic digital advertising content communications device requests the dynamic digital advertising content and/or other factors. In some embodiments, those factors may include a geographic location associated with the request. It will be appreciated that in some embodiments a retailer may only have one location, or may only have one location in a region, or perhaps has a few locations within a region but wishes to use a common set of digital advertising content.

When the user 52 makes a selection, using the digital advertising content communications device 220, that results in a request for corresponding digital advertising content, the front end system 68 may provide the requested digital advertising content to the digital advertising content communications device 220. Again, the particular set of digital advertising content displayed can be representative of the time period in which the digital advertising content is active. For example, the moment in time at which the user 52 makes a selection via the digital advertising content communications device 220, the appropriate set of digital advertising content for that moment in time is displayed on digital advertising content communications device 220. However, in some forms the font end system 68 can be configured to allow the display, via the digital advertising content communications device 220, of past examples or versions of the digital advertising content. Additionally, and/or alternatively, in some forms the front end system 68 can be configured to allow the display on the digital advertising content communications device 220 of upcoming promotions and/or product offerings. In some forms, the displaying of a set of digital advertising content via the digital advertising content communications device 220 can also include the displaying of contact details for the particular retailer/retailer location.

The DDACS 50 is also structured to receive a the back end system 70 a request, via the front end system 68 and in response to engagement of the DDACS 50 of the user using the digital advertising content communications device 220, a set of dynamic digital advertising content be generated that includes a plurality of item cards 1-11 based on a plurality of item card parameters that are customized to the request and current time. In such an embodiment, the item card parameters can be indicative of a customized of each card item 1-11 based on the retailer associated with the digital advertising content. Moreover, such customization may be directed to advertising and prioritizing products in the digital advertising content that are specific to that particular retailer.

In the context of digital circulars, in one non-limiting example, a user 52 can select via the digital advertising content communications device 220 a city name, and thereafter select a particular retailer or retailer location within that city that is associated with a given digital circular 105. To aid the user in selecting a desirable retailer for purchasing goods via the digital advertising content communications device 220, the front end system 68 can also display via the digital advertising content communications device 220 the digital circular 105 in a formation such that a user can click on a map feature. The map feature can be configured direct the digital advertising content communications device 220 to the map application on the digital advertising content communications device 220 where a pin, or other location identifier, can be dropped in a map that is, or will be, displayed on the digital advertising content communications device 220. Selecting the pin by the user via the user interface 260 can either show via the digital advertising content communications device 220 details of the retailer/retailer location, and/or redirect the user 52 to a digital circular 105 prepared for that retailer/retailer location. In some embodiments, the front end system 68 can also provide, via the digital advertising content communications device 220, the ability to call that particular retailer/retailer location through any variety of actions such as clicking a button, a hyperlink, or activating a slider. In this manner, once requested, the digital advertising content communications device 220 is further structured to receive the digital circular 105 generated by the back end system 70 via the front end system 68. Such a received digital circular 105 can include the plurality of item cards 1-11 that are spatially positioned into a corresponding item card partition or cell 117a of the digital layout grid 117 for the digital circular 105.

When the user makes a retailer/retailer location selection using the user interface 260 of the digital advertising content communications device 220, the front end system 68 can request information related to the appropriate digital circular 105 from the back end system 70. Such a request can take the form of a request from an HTTP client using, for example, an API call. The back end system 70 can be configured to serve relevant dynamic digital advertising content, including, for example, a digital circular 105, to the front end system 68 such as content that is stored on the back end system 70 in the form of a web page.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### Conclusion

In one form of the instant disclosure, a dynamic digital advertising content communications system (DDACS) 50 for displaying location-based notifications for digital advertising content for products sold by a retailer includes at least one processor, and a memory coupled with the processor. The memory includes instructions that when executed by the processor, cause the processor to obtain executable code encapsulated as a digital wallet card for a digital wallet of the dynamic digital advertising content communications device. The processor is further configured to enable notification and location tracking services associated for digital wallet cards in the digital wallet. Additionally, the processor is configured to continually determine, with the location tracking services, whether the dynamic digital advertising content communications device is at one of a set of geographic locations defined by a retailer in association with the digital wallet card. In addition, the processor is configured to display, in response to a determination that the dynamic digital advertising content communications device is at one of the set of geographic locations defined by the retailer in association with the digital wallet card, a notification that includes a prompt to select the notification to view the digital advertising content. Further, the processor is configured to request, in response to a determination that the displayed notification was selected, digital advertising content associated with the retailer at a network address defined in association with the notification. Additionally, the processor is configured to obtain, based on the request, the digital advertising content associated with the network address associated with the notification. The digital advertising content includes a promotion for a product sold by the retailer. The processor is further configured to display the obtained digital advertising content to enable a user of the dynamic digital advertising content communications device to readily utilize the promotion when the user is at one of the geographic locations defined by the retailer.

In at least some embodiments, the processor is further configured to display, as the dynamic digital advertising content, a weekly advertisement associated with the retailer.

In yet further embodiments, the processor is further configured to scan a visual code indicative of a uniform resource locator from which to request the digital wallet card. The processor may be further configured to obtain the executable code for the digital wallet card based on requesting the digital wallet card from the uniform resource locator indicated by the visual code.

Additionally, in at least some embodiments, the processor may be further configured to request, in response to a determination that the displayed notification was selected, digital advertising content associated with the retailer at a network address defined in association with the geographic location that the dynamic digital advertising content communications device is determined to be located at.

In some embodiments, the processor may be further configured to append a tag to the network address, wherein the tag is indicative of the geographic location that the dynamic digital advertising content communications device is determined to be located at.

In yet further embodiments, the processor may be further configured to display, in response to a determination that the dynamic digital advertising content communications device is at one of the set of geographic locations defined by the retailer in association with the digital wallet card, a notification with a message that is defined as a function of the geographic location that the dynamic digital advertising content communications device is determined to be located at.

In some embodiments, the processor may be further configured to display, in response to a determination that the dynamic digital advertising content communications device is at a defined geographic location associated with a highway exit, a notification with a message indicating a distance and direction to a location of the retailer.

Additionally, in at least some embodiments, the processor may be further configured to display, in response to a determination that the dynamic digital advertising content communications device is at a defined geographic location associated with a competitor retailer, a notification with a message to redirect the user away from the competitor retailer.

In yet further embodiments, the processor may be further configured to display, in response to a determination that the dynamic digital advertising content communications device is at a defined geographic location of the retailer, a notification welcoming the user to location of the retailer.

In some embodiments, the processor may be further configured to request, in response to a determination that the displayed notification was selected, digital advertising content associated with the retailer at a network address that includes a unique identifier of the dynamic digital advertising content communications device to facilitate analytics.

Additionally, in at least some embodiments, the processor may be further configured to display, as the dynamic digital advertising content, dynamic digital advertising content adapted to incentivize the user to visit the retailer rather than a competitor retailer, wherein an item card indicative of information about a particular product sold by the retailer is positioned or sized within the dynamic digital advertising content based on a determination that the dynamic digital advertising content communications device is located at the competitor retailer, to incentivize the user to visit the retailer rather than the competitor retailer.

In some embodiments, the processor may be further configured to replace, in the memory, the set of defined geographic locations with a subsequent set of defined geographic locations defined by the retailer based on an analytics indicative of patterns or statistics associated with notifications produced by the digital wallet card.

It is to be appreciated that the Detailed Description section, and not the Abstract section, is intended to be used to interpret the claims. The Abstract section may set forth one or more, but not all exemplary embodiments, of the present disclosure, and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) the various changes in form and detail can be made without departing from the spirt and scope of the present disclosure. Thus the present disclosure should not be limited by any of the above-described exemplary embodiments, but should be defined only in accordance with the following claims and their equivalents.

What is claimed is:

1. A dynamic digital advertising content communications device for displaying location-based notifications for digital advertising content for products sold by a retailer, comprising:
at least one processor; and
a memory coupled with the processor, the memory including instructions that when executed by the processor cause the processor to:
obtain executable code encapsulated as a digital wallet card for a digital wallet of the dynamic digital advertising content communications device, wherein the dynamic digital advertising content communications device is configured to enable notification and location tracking services associated for digital wallet cards in the digital wallet;
continually determine, with the location tracking services, whether the dynamic digital advertising content communications device is at one of a set of geographic locations defined by a retailer in association with the digital wallet card;
display, in response to a determination that the dynamic digital advertising content communications device is at one of the set of geographic locations defined by the retailer in association with the digital wallet card, a notification that includes a prompt to select the notification to view the digital advertising content;
request, in response to a determination that the displayed notification was selected, digital advertising content associated with the retailer at a network address defined in association with the notification;
obtain, based on the request, the digital advertising content associated with network address associated with the notification, wherein the digital advertising content includes a promotion for a product sold by the retailer; and
display the obtained digital advertising content to enable a user of the dynamic digital advertising content communications device to readily utilize the promotion when the user is at one of the geographic locations defined by the retailer.

2. The dynamic digital advertising content communications device of claim 1, wherein the processor is further configured to:
display, as the dynamic digital advertising content, a weekly advertisement associated with the retailer.

3. The dynamic digital advertising content communications device of claim 1, wherein the processor is further configured to:
scan a visual code indicative of a uniform resource locator from which to request the digital wallet card; and
obtain the executable code for the digital wallet card based on requesting the digital wallet card from the uniform resource locator indicated by the visual code.

4. The dynamic digital advertising content communications device of claim 1, wherein the processor is further configured to:
request, in response to a determination that the displayed notification was selected, digital advertising content associated with the retailer at a network address defined in association with the geographic location that the dynamic digital advertising content communications device is determined to be located at.

5. The dynamic digital advertising content communications device of claim 1, wherein the processor is further configured to:
append a tag to the network address, wherein the tag is indicative of the geographic location that the dynamic digital advertising content communications device is determined to be located at.

6. The dynamic digital advertising content communications device of claim 1, wherein the processor is further configured to:
display, in response to a determination that the dynamic digital advertising content communications device is at one of the set of geographic locations defined by the retailer in association with the digital wallet card, a notification with a message that is defined as a function of the geographic location that the dynamic digital advertising content communications device is determined to be located at.

7. The dynamic digital advertising content communications device of claim 6, wherein the processor is further configured to:
display, in response to a determination that the dynamic digital advertising content communications device is at a defined geographic location associated with a highway exit, a notification with a message indicating a distance and direction to a location of the retailer.

8. The dynamic digital advertising content communications device of claim 6, wherein the processor is further configured to:
display, in response to a determination that the dynamic digital advertising content communications device is at a defined geographic location associated with a competitor retailer, a notification with a message to redirect the user away from the competitor retailer.

9. The dynamic digital advertising content communications device of claim 6, wherein the processor is further configured to:
display, in response to a determination that the dynamic digital advertising content communications device is at a defined geographic location of the retailer, a notification welcoming the user to location of the retailer.

10. The dynamic digital advertising content communications device of claim 1, wherein the processor is further configured to:
request, in response to a determination that the displayed notification was selected, digital advertising content associated with the retailer at a network address that includes a unique identifier of the dynamic digital advertising content communications device to facilitate analytics.

11. The dynamic digital advertising content communications device of claim 1, wherein the processor is further configured to:
display, as the dynamic digital advertising content, dynamic digital advertising content adapted to incentivize the user to visit the retailer rather than a competitor retailer, wherein an item card indicative of information about a particular product sold by the retailer is positioned or sized within the dynamic digital advertising content based on a determination that the dynamic digital advertising content communications device is located at the competitor retailer, to incentivize the user to visit the retailer rather than the competitor retailer.

12. The dynamic digital advertising content communications device of claim 1, wherein the processor is further configured to:
replace, in the memory, the set of defined geographic locations with a subsequent set of defined geographic locations defined by the retailer based on analytics indicative of patterns or statistics associated with notifications produced by the digital wallet card.

13. A method for displaying location-based notifications for digital advertising content for products sold by a retailer, comprising:
obtaining, by a dynamic digital advertising content communications device, executable code encapsulated as a digital wallet card for a digital wallet of the dynamic digital advertising content communications device, wherein the dynamic digital advertising content communications device is configured to enable notification and location tracking services associated for digital wallet cards in the digital wallet;
continually determining, by the dynamic digital advertising content communications device and with the location tracking services, whether the dynamic digital advertising content communications device is at one of a set of geographic locations defined by a retailer in association with the digital wallet card;
displaying, by the dynamic digital advertising content communications device and in response to a determination that the dynamic digital advertising content communications device is at one of the set of geographic locations defined by the retailer in association with the digital wallet card, a notification that includes a prompt to select the notification to view the digital advertising content;
requesting, by the dynamic digital advertising content communications device and in response to a determination that the displayed notification was selected, digital advertising content associated with the retailer at a network address defined in association with the notification;
obtaining, by the dynamic digital advertising content communications device and based on the request, the digital advertising content associated with network address associated with the notification, wherein the digital advertising content includes a promotion for a product sold by the retailer; and
displaying, by the dynamic digital advertising content communications device, the obtained digital advertising content to enable a user of the dynamic digital advertising content communications device to readily utilize the promotion when the user is at one of the geographic locations defined by the retailer.

14. The method for displaying location-based notifications for digital advertising content for products sold by a retailer of claim 13, further comprising:
displaying, as the dynamic digital advertising content, a weekly advertisement associated with the retailer.

15. The method for displaying location-based notifications for digital advertising content for products sold by a retailer of claim 13, further comprising:
scanning a visual code indicative of a uniform resource locator from which to request the digital wallet card; and
obtaining the executable code for the digital wallet card based on requesting the digital wallet card from the uniform resource locator indicated by the visual code.

16. The method for displaying location-based notifications for digital advertising content for products sold by a retailer of claim 13, further comprising:
requesting, in response to a determination that the displayed notification was selected, digital advertising content associated with the retailer at a network address defined in association with the geographic location that the dynamic digital advertising content communications device is determined to be located at.

17. The method for displaying location-based notifications for digital advertising content for products sold by a retailer of claim 13, further comprising:
appending a tag to the network address, wherein the tag is indicative of the geographic location that the dynamic digital advertising content communications device is determined to be located at.

18. The method for displaying location-based notifications for digital advertising content for products sold by a retailer of claim 13, further comprising:
displaying, in response to a determination that the dynamic digital advertising content communications device is at one of the set of geographic locations defined by the retailer in association with the digital wallet card, a notification with a message that is defined as a function of the geographic location that the dynamic digital advertising content communications device is determined to be located at.

19. The for displaying location-based notifications for digital advertising content for products sold by a retailer of claim 18, further comprising:
displaying, in response to a determination that the dynamic digital advertising content communications device is at a defined geographic location associated with a highway exit, a notification with a message indicating a distance and direction to a location of the retailer.

20. The for displaying location-based notifications for digital advertising content for products sold by a retailer of claim 18, further comprising:
displaying, in response to a determination that the dynamic digital advertising content communications device is at a defined geographic location associated with a competitor retailer, a notification with a message to redirect the user away from the competitor retailer.
